(19) United States
(12) Patent Application Publication
(10) Pub. No.: US 2025/0233914 A1
(43) Pub. Date: Jul. 17, 2025

(54) SYSTEMS AND METHODS FOR ASSIGNING AND USING PRIVILEGES TO ASSIST MANEUVERING AND TRAVEL OF VEHICLES

(71) Applicant: QUALCOMM Incorporated, San Diego, CA (US)

(72) Inventors: Bapineedu Chowdary GUMMADI, Hyderabad (IN); Stephen William EDGE, Escondido, CA (US); Amarnath Reddy POTHIREDDY, Hyderabad (IN); Yatham Sai Sangram REDDY, Bangalore (IN); Bala RAMASAMY, San Marcos, CA (US); Suryakanta MANDAL, Hyderabad (IN); Phani Kumar Jagannadha TANGIRALA, Hyderabad (IN); Phaneendra CHEEKATLA, Hyderabad (IN); Srujith Reddy KATAMREDDY, Ingolstadt (DE); Abha KHOSLA, San Diego, CA (US); Thien NGUYEN, Irvine, CA (US)

(21) Appl. No.: 18/853,837

(22) PCT Filed: Jun. 8, 2023
(86) PCT No.: PCT/US2023/024817

§ 371 Date: Oct. 3, 2024

(30) Foreign Application Priority Data
Jul. 7, 2022 (IN) 202241039053

(51) Int. Cl. H04L 67/12; G08G 9/02; H04L 9/40

(52) U.S. Cl. CPC H04L 67/12; G08G 9/02; H04L 63/123

(57) ABSTRACT

Techniques are described for enabling a device such as a user equipment or in vehicle system to receive permissions related to maneuvering and travel of a vehicle associated with the device. The vehicle may support travel by land, water, air or in space. A privilege-granting authority server may provide a signed document indicating the permissions to the device, where the permissions authorize the vehicle to perform actions related to maneuvering and travel of the vehicle, such as exceeding posted speed limits, using reserved lanes on a highway or receiving favorable traffic treatment. The device may wirelessly transmit messages comprising the signed document to additional devices separate from the vehicle, where the additional devices respond in accordance with the permissions, such as making way for the vehicle. The signed document may include a digital signature and digital certificates to authenticate the permissions.

### RELATED APPLICATIONS

This application claims the benefit of Indian Application No. 202241039053, filed Jul. 7, 2022, entitled “SYSTEMS AND METHODS FOR ASSIGNING AND USING PRIVILEGES TO ASSIST MANEUVERING AND TRAVEL OF VEHICLES”, which is assigned to the assignee hereof, and incorporated herein in its entirety by reference.

### BACKGROUND

A vehicle (e.g., road, airborne, marine, or space vehicle), when in use, typically needs to move from one location to another and/or through a series of locations (e.g. along a predetermined land or sea route, flight path or orbit). There may be impediments and restrictions to such movement—e.g. such as other vehicles and legal requirements concerning when and how such movement can occur.

### BRIEF SUMMARY

Embodiments described herein provide for the obtaining and granting of vehicular privileges using a digitally signed document plus one or more digital certificates, collectively referred to as a “signed document”. The signed document may be sent to a receiving device comprising the vehicle or another device at the vehicle (e.g., a mobile phone), and may be wirelessly transmitted from the receiving device to other nearby devices to alert the nearby devices of the vehicle's privileges. Depending on the type of privilege granted, the nearby devices may respond accordingly. The request and grant for privileges in this manner may allow a privilege-granting authority to provide privileges and grant a corresponding signed document in a relatively fast manner (e.g., in an on-demand or as-needed basis) which may be particularly helpful in emergencies and other urgent situations.

An example method at a device for enabling permissions related to maneuvering of a vehicle, according to this disclosure, may comprise receiving, at the device from a privilege-granting authority server, a signed document indicative of a grant of one or more permissions, wherein the device comprises the vehicle or an associated device, the associated device associated with the vehicle, and the one or more permissions authorize the vehicle to perform one or more actions related to the maneuvering of the vehicle. The method also may comprise subsequent to receiving the signed document, wirelessly transmitting messages comprising the signed document from the device to one or more additional devices separate from the vehicle, wherein the wirelessly transmitting of the messages is configured to invoke a response from the one or more additional devices in accordance with the one or more permissions.

An example method at a privilege-granting authority server for enabling a device to obtain and use permissions related to maneuvering of a vehicle, according to this disclosure, may comprise establishing a communication link between the privilege-granting authority server and the device, the device comprising the vehicle or an associated device, the associated device associated with the vehicle. The method also may comprise sending, from the privilege-granting authority server to the device, a signed document indicative of a grant of one or more permissions, wherein: the one or more permissions authorize the vehicle to perform one or more actions related to the maneuvering of the vehicle, and the signed document is configured to, when wirelessly transmitted from the device to one or more additional devices separate from the vehicle, invoke a response from the one or more additional devices in accordance with the one or more permissions.

An example device for enabling permissions related to maneuvering of a vehicle, according to this disclosure, may comprise a transceiver, a memory, one or more processors communicatively coupled with the transceiver and the memory, wherein the one or more processors are configured to receive, via the transceiver from a privilege-granting authority server, a signed document indicative of a grant of one or more permissions, wherein: the device comprises the vehicle or an associated device, the associated device associated with the vehicle, and the one or more permissions authorize the vehicle to perform one or more actions related to the maneuvering of the vehicle. The one or more processors further may be configured to subsequent to receiving the signed document, wirelessly transmit messages comprising the signed document from the device to one or more additional devices separate from the vehicle, wherein the wirelessly transmitting of the messages is configured to invoke a response from the one or more additional devices in accordance with the one or more permissions.

An example privilege-granting authority server for enabling a device to obtain and use permissions related to maneuvering of a vehicle, according to this disclosure, may comprise a transceiver, a memory, one or more processors communicatively coupled with the transceiver and the memory, wherein the one or more processors are configured to establish a communication link between the privilege-granting authority server and the device, the device comprising the vehicle or an associated device, the associated device associated with the vehicle. The one or more processors further may be configured to send, via the transceiver to the device, a signed document indicative of a grant of one or more permissions, wherein: the one or more permissions authorize the vehicle to perform one or more actions related to the maneuvering of the vehicle, and the signed document is configured to, when wirelessly transmitted from the device to one or more additional devices separate from the vehicle, invoke a response from the one or more additional devices in accordance with the one or more permissions.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration depicting an overhead view of an example road traffic scenario.

FIG. 2 is an illustration depicting an example scenario related to aerial vehicles in general.

FIG. 3 is an illustration depicting an overhead view of an example scenario of marine vehicles navigating a waterway.

FIG. 4 is a message-flow diagram of a process for requesting and granting vehicle permissions, according to an embodiment.

FIG. 5 is a version of the flow diagram of FIG. 4, in which all processes may be performed automatically by electronic devices, according to an embodiment.

FIG. 6 shows example data that can be included in a signed document to establish permissions, or privileges, according to an embodiment.

FIGS. 7A and 7B shows example message structures that could be used in some embodiments.

FIG. 8 is a flow diagram of a method at a device for enabling permissions related to maneuvering of a vehicle, according to an embodiment.

FIG. 9 is a flow diagram of a method at a privilege-granting authority server for enabling a device to obtain and use permissions related to maneuvering of a vehicle, according to an embodiment.

FIG. 10 is a block diagram of an embodiment of a device, which can be utilized as part of a vehicle (e.g., an electrical system of a vehicle) or as an associated device (e.g., mobile device, mobile phone, etc.) as described herein.

FIG. 11 is a block diagram of an embodiment of a computer system.

Like reference symbols in the various drawings indicate like elements, in accordance with certain example implementations.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology. Further, vehicle-related RF signals may be communicated using relevant wireless communication technologies and/or standards related to vehicle-to-vehicle (V2V), vehicle-to-infrastructure (V2I), vehicle-to-network (V2N), vehicle-to-pedestrian (V2P), and/or vehicle-to-everything (V2X) communication, or similar types of communication. As used herein, V2V, V2I, V2N, and V2P, as well as cellular based variants (e.g., cellular V2X or CV2X), may be considered different types of V2X communication.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Also, as used herein, a “privilege” generally refers to a permission granted to a vehicle by an authority, enabling the vehicle to perform an action it may not otherwise be authorized to perform. Thus, the terms “privilege” and “permission” may be used interchangeably. As described in more detail herein, a digitally signed document plus one or more digital certificates, collectively referred to herein as a “signed document”, may be provided to, and communicated by, the vehicle as evidence of granted privileges, which can evoke responses from receiving devices to help enable the vehicle to exercise these privileges.

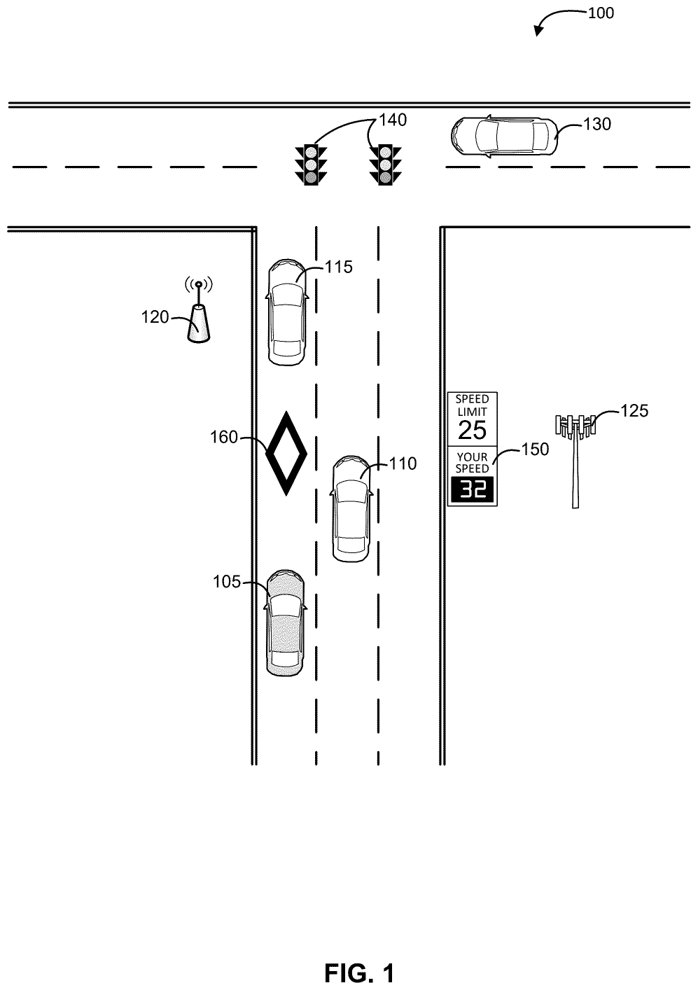

As previously noted, a vehicle may obtain certain privileges or permissions in order to maneuver in a certain way during the course of ordinary or extraordinary travel. These permissions may vary depending on factors such as the type of vehicle, the nature of the intended maneuver(s) and/or travel and relevant privilege-granting authority (referred to herein as a “privilege-granting authority”), and may be permanent or temporary. Permissions may allow a vehicle to get to a destination faster, access certain areas or locations otherwise inaccessible, or the like. As noted, vehicles may vary in type, and may include road vehicles, airborne vehicles, marine vehicles, and/or space vehicles. Examples of different types of vehicles and privileges are described with respect to FIGS. 1-4.

FIG. 1 is an illustration depicting an overhead view of an example traffic scenario 100 in which a vehicle 105 (a road vehicle in this example such as a car or truck) can obtain one or more privileges that can impact how it maneuvers over the course of travel. For example, the vehicle 105 may have a need to reach its destination urgently, but may face delay from impediments such as traffic intersections, tollbooths, speed limits, road works, lane closures or restrictions, traffic congestion, and/or the like. Privileges may be granted by a privilege-granting authority (not shown) to enable the vehicle 105 to move more quickly through traffic and reduce or avoid delay from impediments.

Privileges in a road traffic scenario such as the traffic scenario 100 of FIG. 1 may be granted for any of a variety of reasons. For example, VIPs (e.g. diplomats and Government officials), doctors, public officials etc. may need fast and efficient road access in the public interest by avoiding delays. The transport of concrete to a building site may be subject to time limitation to avoid concrete setting. The transport of legal documents may be subject to delivery time constraints. Health and public safety workers may have travel time deadlines. Attendees at important events may need assistance to arrive in time. An airport traveler may need to travel to an airport to catch an imminent flight.

The privilege-granting authority (also referred to herein as the “authority”) may vary in different situations and circumstances. In general, the privilege-granting authority may correspond to an organization which controls the infrastructure like a government, a local authority for a town, city or state, or a private entity, e.g. to which a government or local authority might have outsourced the management of vehicle related privileges (e.g. road privileges). A signed document may then be applicable only in a corresponding region of control of the respective privilege-granting authority. In some instances, a signed document can be applicable to multiple jurisdictions based, for example, on an existing mutual agreement between respective privilege-granting authorities for those jurisdictions. Thus, if a vehicle moves from a region governed by one authority to a region governed by another authority, it may request different privileges (or signed documents) from different authorities or may be able to use a signed document provided by one authority in regions governed by other authorities. For example, if a vehicle moves from one state to another or across multiple states, the vehicle may need to request multiple signed documents if the states are governed by different authorities or may possibly be enabled to use one signed document in all states, e.g. if the signed document was provided by a national authority. It can be noted that the region or jurisdiction of an authority may not be strictly defined by definite boundaries because it may be difficult to define an accurate boundary. Thus, there may be an intersection between regions where two (or more) authorities can govern control, in which case a signed document from either (or any) of the authorities may be deemed valid.

As described above and as used herein, the term “signed document” refers to a document that indicates one or more privileges and/or priorities assigned temporarily or permanently to a vehicle, a device associated with a vehicle (e.g. a modem or “in vehicle system” used for communications) or a device belonging to a user, operator or passenger of a vehicle. For example, the document may explicitly list and name each of the one or more privileges and/or priorities, or the document may contain an encoding (e.g. a binary ASN.1 encoding) of each of the one or more privileges and/or priorities. The document may be a text document (e.g. encoded as unformatted text and possibly using the Extensible Markup Language (XML)) or a binary document (e.g. encoded using the Abstract Syntax Notation One (ASN.1)). The document can be signed using a digital signature, e.g. which may be based on a public key-private key pair, where the digital signature may comprise a ciphering using the private key of a hash (based on a known or identified hash algorithm) of the contents of the document. The document may be authenticated by a recipient of the document by verifying the digital signature. For example, for a digital signature based on a public key-private key pair as just described, the recipient may decrypt the digital signature using the public key and verify the decrypted result matches a hash of the document, which may be obtained by the recipient using the same known or identified hash algorithm. In this example, the public key used by the recipient to verify the digital signature may be provided and authenticated by one or more digital certificates, e.g. digital certificates defined according to ITU X.509 or IETF RFC 5280, which may be provided along with the document and the digital signature. The collection comprising the document indicating the one or more privileges and/or priorities related to a vehicle, the digital signature and the one or more digital certificates, if included, is referred to herein as a “signed document”. A signed document may also be referred to as a certificate, a signed certificate, a privilege certificate or by some other name. The use of digital signatures (e.g. based on public key-private key pairs) to authenticate documents and the use of digital certificates to provide and authenticate public keys is widely known in the art. It is noted that the term “unsigned document” is used herein to refer to a document indicating one or more privileges and/or priorities related to a vehicle but without a digital signature or one or more digital certificates.

Depending on desired functionality, a signed document may be granted and used in different ways. A vehicle receiving privileges via the signed document may include a permanent onboard user equipment (UE) with Vehicle-to-everything (V2X) wireless communications capability. In such instances, a signed document enabling the privileges may be permanently or temporarily configured in the onboard UE. Alternatively, a separate UE associated with the vehicle, such as a driver's or passenger's mobile phone, may be used. In the latter case, the separate UE may act as a proxy UE for the vehicle. In either case, the UE (the permanent onboard UE or separate UE associated with the vehicle) may receive the signed document and transmit (e.g., via unicast or broadcast) to other devices in the area using V2X (e.g., using 4G/5G sidelink signaling) to obtain various driving privileges and this can be applicable for a duration of time defined in the signed document or until a new signed document is issued with changed privileges.

A vehicle, e.g. the vehicle 105 in FIG. 1, may send the signed document to any of a variety of nearby vehicles and devices, depending on the scenario and privilege. For example, in the traffic scenario 100 of FIG. 1, the vehicle 105 that receives a signed document granting various privileges may transmit the signed document to one or more nearby vehicles 110, 115, a roadside unit (RSU) 120, and/or a cellular base station 125. In some instances, a receiving device may propagate the signed document to other devices. For example, the roadside unit 120 or cellular base station 125 may relay the signed document to a more distant vehicle 130 that may be outside the range of direct RF communication with the privileged vehicle 105, but which may still be impacted by the privileges of the privileged vehicle 105. In some instances, traffic-related devices such as traffic lights 140 and radar 150 may receive the signed document directly from the privileged vehicle 105, or may receive the signed document and/or another indication that the vehicle 105 has a particular privilege, via another device, such as a roadside unit 120, that may manage the traffic-related devices.

The types of permission granted can vary in different traffic scenarios. Privileges can include, for example, permission to exceed posted speed limits up to a certain limit without being stopped/ticketed, access to predetermined or reserved parking spots, permission to use toll roads and pass through toll areas without delay and/or without paying, access to reserved driving lanes (e.g. High-Occupancy Vehicle (HOV) lane 160 or some other high priority lane), causing traffic lights (e.g., traffic lights 140) at a traffic intersection to change to green when (or just before) arrival at the intersection, or permission to use detours and short cuts (not available to other vehicles) to circumvent areas of traffic congestion, road works, lane closures and/or road closures, or a combination thereof. According to some embodiments, the signed document can have rules allowing all or a subset of available privileges. Moreover, privileges may be restricted to a specific route or routes, a speed range, a specific area or areas, particular days and/or times of day, and/or a particular time period after which the signed document expires. According to some embodiments, RSUs obtain the location and/or speed and direction of the privileged vehicle and manage traffic-related devices to help enable certain privileges (e.g., instructing traffic lights to turn green as a privileged vehicle approaches).

The decision by a privilege-granting authority to grant a privilege to a vehicle may be based on any of a number of factors. For instance, some privileges may only be granted to certain types of vehicles. Emergency vehicles and/or vehicles escorting VIPs, for example, may be the only types of vehicles to access privileges such as having traffic lights turn green as they approach an intersection. Some privileges may be granted based on payment (e.g., paying to access an HOV lane, a privileged route, etc.). Other privileges may be based on need, such as a health emergency. Additional details are provided hereafter regarding processes that may be used for requesting and granting privileges.

Depending on the privileges granted, receiving devices (devices that receive the signed document from a privileged vehicle) may respond in accordance with a granted privilege to implement or exercise the privilege. For example, in some embodiments, a privilege may comprise assistance in overtaking non-privileged vehicles. In traffic scenario 100, this may mean allowing the privileged vehicle 105 permission to exceed the existing speed limit as well as instructing to nearby (non-privileged) vehicle 115 to move to another lane. The instruction to the nearby vehicle 115 may be sent from the RSU 120 or from the privileged vehicle 105 itself (e.g., via a V2X message). If the nearby vehicle 115 is an automated (self driving) vehicle, the nearby vehicle 115 may change lanes automatically. Otherwise, the instruction may come via a voice or text message to the driver of the nearby vehicle 115. If a receiving device does not recognize the privilege (e.g., due to an invalid signed document/mismatching authority or because the receiving device was not implemented or configured to recognize or support the privilege, etc.) or is unable to enable a privileged vehicle to exercise the privilege, the receiving device can send a message to the privileged vehicle (e.g., via V2X) to indicate to the privileged vehicle that no action will be taken by the receiving device to implement/exercise the privilege.

It can be noted that a signed document may not be capable of guaranteeing elevated privileges. That is, the granting of a privilege by a privilege-granting authority may not necessarily lead to a privileged vehicle receiving, or exercising, the privilege in all circumstances. Receiving the privilege may, for example, depend on a priority status of the privilege or privileged vehicle, along with the privileges of nearby vehicles. For example, in the traffic scenario 100, if nearby vehicle 115 has privileges similar to the privileged vehicle 105, the privileged vehicle 105 may not be able to exercise the privilege of overtaking the vehicle 115. Similarly, if the vehicle 130 as a privilege for receiving green lights at an intersection (e.g., green traffic lights 140), it may not be possible for the privileged vehicle 105 with the same privilege to exercise this privilege in the instance where both approach an intersection at proximately the same time. According to some embodiments, a priority may be used to determine which vehicle receives a privilege when a conflict like this arises.

Depending on desired functionality, a priority may relate to a status of the vehicle itself (e.g., a vehicle having VIP status), a status of a user, or owner of a UE, associated with the vehicle, and/or a status of a privilege/permission (e.g., a privilege having an associated high-priority status). According to some embodiments, a priority level related to privileges and/or a vehicle status may be explicitly defined in a signed document granted by a privilege-granting authority. Moreover, multiple priority levels may be established such that a vehicle with a higher priority can override the privileges of a lower-priority vehicle, if the privilege of the lower-priority vehicle would conflict with the privilege of the higher-priority vehicle. Depending on desired functionality, a priority associated with a privilege may be established on a per-privilege basis (e.g., each privilege that a vehicle has may have its own priority), or may be established on a per-vehicle basis (e.g., all privileges of a vehicle or of a UE associated with a vehicle may have the same priority). In general, when a conflict exists for implementing a privilege for two vehicles, the privilege for the higher-priority vehicle/privilege can be exercised at the expense of the lower-priority vehicle/privilege, and a privilege for a privileged vehicle having any priority (e.g., a vehicle with a signed document granting the privilege) can be granted over a vehicle having no privilege/priority.

According to some embodiments, a receiving device that receives a signed document may use rules for determining how to respond to one or more privileges associated with the signed document. These rules can be defined according to the privilege and any associated priority and implemented by a device that receives a signed document from a privileged vehicle, such as an RSU. For example, an RSU may implement privileges of a privileged vehicle (e.g., instructing traffic lights to turn green as a privileged vehicle approaches, instructing tollbooths to waive tolls and/or lift control arms, etc.), and may further prioritize implementing higher-priority privileges over lower-priority privileges where a conflict exists. In addition or as an alternative to priority, RSUs (and other receiving devices) can decide to implement privileges based on other factors, such as consequences if privileges are implemented/denied, available resources for implementing a privilege, historical data regarding the vehicle and/or vehicle user, time at which the RSU receives a request for the privilege (e.g., a timestamp for receiving a signed document from a privileged vehicle), or a combination thereof.

In some embodiments, a user score (or user rating) or vehicle score (or vehicle rating) relating to a vehicle driver/user may be established to facilitate this determination. For example, a database of user scores (or ratings) may be established based on users' traffic violation records. The database may be accessible (e.g. via the Internet or via dedicated signaling links) to certain devices, such as RSUs, which support vehicle privileges. In circumstances where such a device (e.g. an RSU) may need to decide between implementing conflicting privileges for two vehicles where the privileges have the same priority, the device can decide for which vehicle it will implement the privilege based on the user score (or rating) and/or other factors. In cases where a priority and/or other factors result in a tie or otherwise fail to indicate which vehicle should receive the privilege, the vehicle can be chosen randomly. According to some embodiments, a database may be kept for cases in which a vehicle was denied a privilege (e.g., in cases where another vehicle was given higher priority), which may be used as a factor for a subsequent determination of whether to implement a privilege. Using this information, a device (e.g. an RSU) can help ensure that a vehicle that gets denied a privilege in one instance may have a higher likelihood of exercising a privilege at a subsequent instance.

As noted, receiving devices such as RSUs and nearby vehicles may respond to enable a privileged vehicle to exercise one or more of its privileges. To further enable this, in addition to transmitting the signed document, the privileged vehicle may communicate information (e.g., via V2X), using one or more messages that may also comprise the signed document, that may indicate the privileged vehicle's presence, velocity, location, directive/purpose, or a combination thereof. This may allow receiving devices to respond accordingly to grant privileges. In the traffic scenario 100 of FIG. 1, for example, the privileged vehicle 105 may communicate its location and velocity to the nearby vehicle 115, thereby enabling the nearby vehicle 115 (in view of its own location) to know how much time it has to change lanes in order to allow the privileged vehicle 105 to proceed in the HOV lane 160 unimpeded.

As previously noted, a privileged vehicle may communicate a signed document to one or more receiving devices by broadcast, group cast/multicast, or unicast. In the case of broadcasting, the periodicity of broadcasting may be based on the speed of the vehicle and/or the density of the vehicles in the surroundings. The higher the speed and/or the greater the vehicle density, for example, the more frequently the privileged vehicle may transmit the signed document. According to some embodiments, the decision as to whether to broadcast, group cast (also known as multicast), or unicast the signed document may depend at least in part on the type of privilege granted. For example, a privileged vehicle that has been granted the privilege of receiving green traffic lights when approaching an intersection may not impact the maneuvering of other vehicles. Consequently, the privileged vehicle may unicast the signed document associated with that privilege to an RSU or directly to a traffic light equipped with RSU capability and not employ broadcast or group cast. However, if the privileged vehicle has other privileges associated with the signed document that may impact the maneuvering of nearby vehicles, the privileged vehicle may also (or instead) communicate the signed document by unicast, group cast (or multicast), or broadcast to both nearby vehicles and RSUs.

Depending on desired functionality, embodiments may limit the ability or frequency of a vehicle to request one or more privileges. In some embodiments, for example, a vehicle may be prevented from requesting a signed document granting one or more privileges unless required to do so to reach a certain destination (e.g. a destination associated with an important national level or international level meeting or event) or a certain or any destination by a certain time (e.g. if the purpose of travel met certain priority conditions). Furthermore, in some embodiments, a vehicle may send a request only when there is heavy traffic (e.g., above a certain threshold) or only if there are a number of traffic lights (e.g., above a threshold number) which could delay the vehicle to reach its destination.

In some embodiments, for example, one or more privileges may be granted to a vehicle in an emergency situation, effectively enabling the vehicle to become, or at least act as, a temporary emergency vehicle. A privilege-granting authority may determine to provide a vehicle with such privileges under certain conditions, such as if there are no ambulances or other emergency vehicles available to reach a vulnerable person (e.g., experiencing a medical emergency) under a threshold amount of time (e.g. which may vary, depending on the type of medical emergency). In such instances, the driver of a non-emergency vehicle may be capable of transporting the vulnerable person to a hospital, and may therefore request privileges to enable the vehicle to become, or to act as, a temporary emergency vehicle. This may occur, for example, when a Public Safety Answering Point (PSAP) (e.g., emergency services/911 dispatcher), receives an emergency call from the driver or vulnerable person and determines that no ambulances are available to take the vulnerable person to an emergency room in time to effectively treat the medical emergency. In this example, the PSAP may act as the privilege-granting authority and provide to a device associated with the driver (e.g., the drivers car or a UE associated with the driver/vulnerable person) the signed document via the Internet and/or a wireless network (e.g., cellular, Bluetooth, and/or Wi-Fi network). To help protect against false alarm/fraud, the privileges associated with the temporary emergency vehicle may grant privileges only for a limited amount of time (e.g., approximately the maximum amount of time needed to drive the vulnerable person to an emergency room) and within a certain area (e.g. defined by a geo-fence/geopolygon and covering one or more routes from the vulnerable user's current position to the emergency room). In some embodiments, the device associated with the driver that receives the signed document (e.g., the vehicle or UE associated with the vehicle) may alert the driver if the vehicle is approaching the limits of the privileges. For example, the device may warn the driver if the time period associated with the privileges is about to expire and/or if the vehicle is approaching a geographical boundary for the privileges.

As noted previously, some privileges may be granted based on payment by a user. In some embodiments, the amount of the monetary charge for the privileges may vary based on factors like the number of users (e.g. passengers) making use of using the signed document, the nature of the privileges, a priority requested in the signed document, a time period of usage, an area of usage or the like. For example, the cost of receiving privileges for travel within a dense urban area (e.g. downtown New York City) during a rush-hour may be considerably higher than the cost of the same privileges for use in a small town or at a period of low traffic (e.g. at night or very early in the morning). The monetary charge can also be dependent on the authority. For example, for the same priority/conditions, the charge by one authority can be higher than that of another. This can also depend on factors like taxation requirements of an authority, revenue needed by the authority, or the like.

According to some embodiments, receiving devices may verify the authenticity of a signed document or unsigned document by interacting in real time with a privilege-granting authority that may be indicated in the signed document or unsigned document. For example, the receiving device may interact with a computer server maintained by the privilege-granting authority. Such interaction is referred to here as “real time document verification”. For example, a receiving device may send a message to the privilege-granting authority (or an associated server) and include the signed document or unsigned document or indicate one or more privileges claimed by a vehicle as well possibly as an identification of the vehicle and/or an identification of the signed or unsigned document. The privilege-granting authority (or an associated server) may then respond to the receiving device and indicate whether the signed or unsigned document or the privileges claimed by the vehicle are authentic. In such cases, an unsigned document may just indicate a set of privileges (and priorities), an identity (e.g. a name or number) of the unsigned document and/or of the vehicle and not include extra information authenticating the unsigned document, since the authentication may then be performed in real time through the interaction between the receiving device and the privilege-granting authority. To facilitate such interaction, the privileged vehicle may include an identity of the granting authority when communicating the signed or unsigned document to a receiving device, or the signed or unsigned document may include the identity of the granting authority as part of the signed or unsigned document. In order for such interactive verification to be secure, the receiving device may be configured with the identities (e.g. Internet addresses) of known and trusted privilege-granting authorities and may perform the verification only if a privilege-granting authority indicated in a signed or unsigned document or by a vehicle or device providing a signed or unsigned document is one of the privilege-granting authorities configured in the receiving device.

According to some embodiments where real time document verification is used, a privilege-granting authority may maintain a log indicating the times at which a signed or unsigned document is verified for a receiving device (e.g. an RSU) in order to obtain some privilege. In embodiments in which monetary charges are associated with the privilege, the log may be used to determine the corresponding charge (e.g. which may then be charged to the privileged vehicle user or owner at a later time).

In some embodiments, the privilege-granting authority may limit the number of uses of a signed document to prevent over usage and retain the value of the privilege. For example, the privilege-granting authority may have a predefined limit for the number of signed documents for certain privileges it can or will provide. In some embodiments, priorities associated with different privileges may be adjusted if this limit is approached. For example, if a number of signed documents to be issued exceeds a predefined limit for a particular privilege, a number of lower-priority privileges can be reduced, and/or the lower-priority privileges could be cancelled.

The types of users/vehicles to which privileges are granted may vary, depending on desired functionality. Permanent users, for example, may include users for which privileges may be granted permanently, or for an extended period of time. These users can include, for instance, VIPs, tourist vehicles, government/authority vehicles, transit vehicles, and/or others. In some embodiments, other users for which privileges are granted for an extended period of time (e.g., one year or longer) may be considered “permanent” users in some regards, such as when determining priority associated with granted privileges. In some embodiments, a permanent user having a privilege that is granted permanently (or for a long period of time) may be granted a temporary privilege with a higher priority on occasions in which a higher priority may be needed.

Temporary users may include users for which privileges may be granted on a temporary basis, for a more limited period of time (e.g., for a single trip, a day/week/month, etc.). A priority associated with temporary privileges may be based on need, depending on the purpose for which the privileges are sought. For example, a passenger running late to catch a flight may contact the airline or airport to obtain road privileges (e.g., at a monetary cost) in order to reach the airport in a timely manner. In this example, the airline or airport may operate as the privilege-granting authority, and may be granted such authority by a government or local authority. If a payment was received by the airline/airport for a privilege, the airline/airport may transfer part or all of this payment to the government or local authority. In another example, a university may issue road privileges to their students during examinations. In another example, users (e.g., drivers) may pay additional vehicle license or registration fees to obtain limited extra privilege and/or particular types of vehicle and/or vehicle owners may receive an automatic set of privileges. Motorcycles and electric vehicles, for example, may be automatically granted a privilege to access HOV lanes.

According to some embodiments, privileges and/or associated priorities may be updated, removed or relinquished after being granted to a vehicle, device or user. This can be done, for example, by the vehicle or device in the case of update or relinquishment or by a server of a privilege-granting authority. According to some embodiments, a server of a privilege-granting authority can keep track of a first vehicle, to which privileges were assigned, using information from sources like RSUs, the first vehicle itself or other vehicles. The server can also consider additional information such as the number of higher priority and/or higher privilege vehicles on a designated route for the first vehicle and/or nearby to the first vehicle which might delay the first vehicle. If the server determines that the first vehicle might fall behind a known set of travel times or targets, the server could upgrade the privileges and/or priority—e.g. by providing an updated signed document to the first vehicle or to a device associated with the first vehicle. The upgrading of the privileges and/or priority might incur an additional charge to the user. The additional charge can be based on several factors like the extent of the privilege and/or priority upgrading, a number of other vehicles with similar privilege and/or priority, etc.

According to some embodiments, the granting of privileges in the manner described herein can enable privileged vehicles to receive faster travel on freeways and highways. For example, with self-driving vehicles, vehicles having appropriate privileges (e.g., “high-speed” or priority lane access) may be moved into less congested lanes while vehicles not having such privileges are moved out of these lanes. With manually-operated vehicles having a driver alerting capability, drivers of un-privileged vehicles may be warned to exit a lane or not enter a lane if the lane is occupied by one or more vehicles having privileges. On the other hand, with manually-operated vehicles, drivers of vehicles having the appropriate privileges may be given assistance with lane changing, such as being advised which lane to move into on a highway and when to change lanes.

Although many of the previously-described aspects regarding the granting and use of privileges have been described with regard to road or ground vehicles (e.g., the traffic scenario 100 of FIG. 1), many of these aspects can be applied to non-road and/or non-ground vehicles and other applications. As noted, other applications may involve airborne vehicles, marine vehicles, or space vehicles.

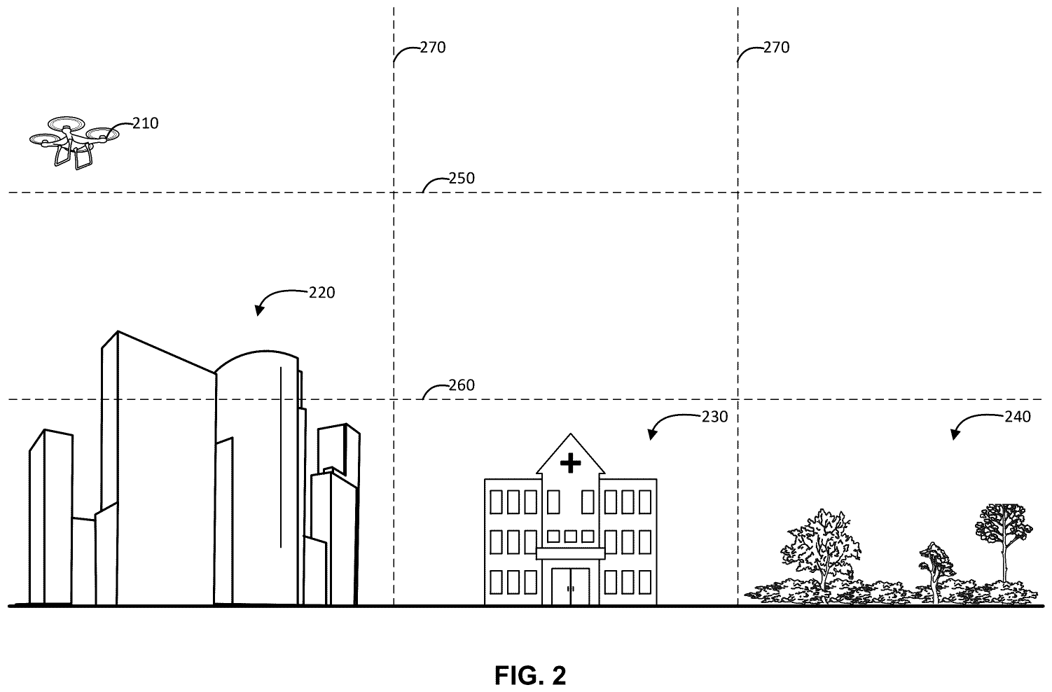

FIG. 2 illustrates a scenario related to aerial vehicles in general, provided to discuss some aspects that may be unique to aerial vehicle applications. Although FIG. 2 illustrates an unmanned aerial vehicle (UAV) 210 (e.g., a commercial or private drone), aspects described herein regarding aerial vehicles may apply to other types of aerial vehicles, including manned and unmanned aircraft (e.g., helicopters, airplanes, gliders, balloons, etc.).

Similar to the manner in which ground vehicles can be granted privileges/permissions related to travel/maneuvering to reduce delay in traveling (e.g., described with respect to FIG. 1), embodiments may extend to aerial vehicles. In particular, aerial vehicles may be granted certain privileges/permissions for flying by a relevant privilege-granting authority. In the case of aerial vehicles, a privilege-granting authority may comprise a government, agency, local authority, or other entity having jurisdiction over aerial travel. Privileges may be granted based on various factors such as a priority, requirements, purpose of travel, aerial vehicle type, etc. For example, different types of aerial vehicles may be given different types of privileges. These types may include, for example, military and government aerial vehicles, commercial aerial vehicles, private aerial vehicles, aerial vehicles related to farming, forestry, mining or public safety, and the like.

In addition to many of the types of privileges previously described with regard to road vehicles (e.g., loosened speed restrictions, access to certain lanes/routes, etc.), there may be other privileges that may be unique to aerial travel. For example, different restrictions may apply to aerial travel over certain areas, and privileges may grant exceptions to some of these restrictions.

According to some embodiments, different types of areas may impose different standardized restrictions on aerial travel over such areas. In an example with eight area types, areas may be defined as:
Area 0: Airports, landing strips, runways;
Area 1: Military areas/confidential areas (President's palace, defense headquarters, etc.);
Area 2: Schools/Hospitals;
Area 3: Dense urban areas;
Area 4: Residential areas;
Area 5: Large gathering areas like parks, theme parks etc.;
Area 6: Urban areas; and
Area 7: Others (e.g. rural areas).

Different restrictions may apply to different types of areas, where some types are more restrictive than others. In this example, area types 0-3 may be much more restrictive to air travel then area types 4-7.

Additional factors may determine which types of areas (or, more generally which types of aerial travel restrictions) may apply. This can include, for example whether areas include private land/public land in rural, suburban, urban regions. Based on applicable landowner rights, private landowners may enforce a minimum altitude at which aerial vehicles may fly over privately-held land. Some restrictions, including such minimum-altitude restrictions, may be lifted upon payment of an applicable fee (e.g., an access fee).

Returning to FIG. 2, for example, different area types include a dense urban area 220, a hospital area 230, and a rural area 240. The dense urban area 220 may include high-rise buildings and other obstacles that may result in restrictions of any aerial travel, or at least any area travel below a relatively high minimum altitude 250 (e.g. such as 300-2000 feet depending on building heights). The hospital area 230 may be less restrictive, imposing a restriction on aerial travel below a relatively low minimum altitude 260 (e.g. such 100-200 feet). The rural area 240, which may include unoccupied public or private land, may have even fewer restrictions, imposing a restriction on aerial travel below the relatively low minimum altitude 260, if at all. As the aerial vehicle 210 passes boundaries 270 from one area to another, different restrictions may apply and (in some cases) privileges for aerial travel may be acquired from different privilege-granting authorities.

Different privileges may apply to different areas. For example, in the dense urban area 220, privileges may be granted for flying below the relatively high minimum altitude 250 and even the relatively low minimum altitude 260. This can enable commercial delivery drones, for example, to deliver a payload to a target in the dense urban area 220 or a helicopter to land on and take off from the roof of a building. These privileges may be restricted to a certain airspace directly above the target location. With respect to the hospital area 230, which may have air travel related to medical helicopters arriving at and/or leaving from the hospital, privileges may be granted to an aerial vehicle 210 to fly over the hospital area (e.g., above the relatively low minimum altitude 260) during periods of time when no medical helicopter traffic is expected. With regard to the rural area 240, privileges may be granted to fly below a minimum altitude (e.g., the relatively low minimum altitude 260) at certain times, based on a payment of fees, etc.

According to some embodiments, a privilege-granting authority may take into account different aspects of the aerial vehicles travel, characteristics, and/or capabilities when determining whether to grant certain permissions to the aerial vehicle. These aspects may include, for example, the weight of the aerial vehicle and/or its payload, the range/distance the aerial vehicle intends to travel, the speed at which the aerial vehicle will travel, a maximum time the aerial vehicle can spend in the air based on fuel/battery level and/or thermal capabilities, a maximum altitude the aerial vehicle can travel, conditions that may impact the aerial vehicle and/or others (e.g. noise generated, durability, etc.), or a combination thereof. When requesting permissions from a privilege-granting authority, an aerial vehicle may share this information with the privilege-granting authority, along with other details the privilege-granting authority may request (e.g., origination, destination, etc.).

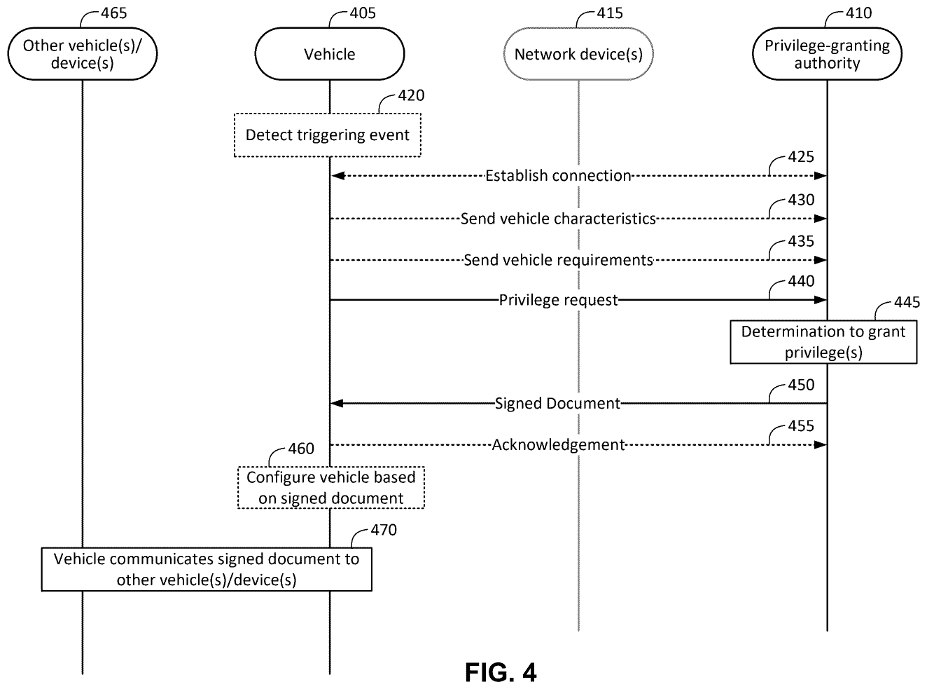

General details regarding the process of requesting and granting of privileges for vehicle travel (for any vehicle type) that embodiments may employ are described hereafter with respect to FIGS. 4-9. However, with respect to aerial vehicles, an example process may proceed as follows. First, permissions related to aerial travel may be requested and obtained by the aerial vehicle or an entity related thereto (e.g., an aerial vehicle controller). This may be performed before and/or during flight. The aerial vehicle may interact with a controller (e.g., using direct and/or indirect wireless RF communication) to provide location and flight details and receive instructions (e.g., to proceed or stay at/return to origin). In some embodiments, the controller may interact with a privilege-granting authority. In some embodiments, the aerial vehicle may interact with the privilege-granting authority directly.

In some instances, permissions may be modified or revoked during flight, depending on different circumstances. The modification or revocation of permissions can be based, for example, on a change in requirements or dynamic change in relevant regulations. For example, if an emergency situation arises for one or more aerial vehicles in a region, privileges for certain other UA Vs which are already assigned may be revoked by a privilege-granting authority or an associated server, e.g. by sending an updated signed document from the server to each of the other UAVs or by sending an indication from the server to each of the other UAVs indicating that the already assigned signed documents have been revoked. If an aerial vehicle has a sudden emergency midway or is falling behind on a flight schedule, it can request additional permissions and/or heightened priority from a privilege-granting authority, e.g. in order to react appropriately to the emergency (e.g. such as landing as soon as possible) or catch up on the flight schedule.

As previously noted, different permissions may apply to the airspace above different types of areas. Moreover, permissions may be received/denied, revoked, or modified before or during flight. Permissions that may be requested and granted may relate to flying into certain areas (e.g., latitude/longitude permissions), flying at/above/below certain altitudes (altitude permissions), flying at certain speeds (speed or velocity permissions), flying along certain routes, taking off from and/or landing at certain locations, carrying (or not carrying) certain cargo, or a combination thereof. Moreover, as noted, the granting of such permissions may be based in part on various characteristics related to the type of aerial vehicle, its capabilities, its intended travel route, aerospace restrictions, and the like. For example, speed or velocity based permissions may be granted to allow an aerial vehicle to reach its destination by a certain desired time. Permissions allowing an aerial vehicle to travel at lower altitudes and lower velocities (e.g., along a route above uncrowded areas) may be granted to aerial vehicles carrying a heavy payload. Permissions allowing a relatively noisy aerial vehicle to travel along a route above uncrowded areas may be preferable to permissions allowing travel near schools or hospitals. That said, permissions may be granted during holidays for travel in airspace above schools or other areas that are closed for the holiday. Other time-based permissions may include requiring higher travel during nighttime or daytime, depending on an area, to reduce disturbance.

As noted, the purpose of travel may impact which permissions are granted. An aerial vehicle traveling in an urgent emergency situation (e.g., carrying critical medicine, medical supplies, a badly injured person, etc.) may be given a high priority with permission to travel at any speed at a low altitude. On the other hand, an aerial vehicle traveling for a non-emergency purpose may be giving a relatively low priority with a higher minimum-altitude restriction. Other restrictions on speed, altitude, etc. may apply in cases where the purpose of travel is less urgent.

The denial of permissions may be based on any of a variety of factors as well. If a privilege-granting authority determines certain requested permissions would result in unsafe travel, the permissions may be denied. This may be based, for example, on aerial vehicle capabilities, current weather conditions (wind, rain, fog, smoke, smog, etc.), current battery/fuel levels, etc. The presence of other air traffic may also play a role in denying permissions in cases where granting the permissions may increase the likelihood of collision between aerial vehicles to an unsafe level.

Similar to the road traffic examples described previously, priority may play a role. The purpose of travel and aerial vehicle type, for example, may play a role in the determination priority. In particular, certain aerial vehicle types (e.g., military and government aerial vehicles) may be given priority over other aerial vehicle types (e.g., private aerial vehicles) when granting certain permissions. Additionally or alternatively, certain permissions may have an associated priority, which again may be based on aerial vehicle type, purpose, etc. Thus, aerial vehicles having lower priority may not have access to the same areas/altitudes as higher-priority aerial vehicles, especially in in high-traffic scenarios.

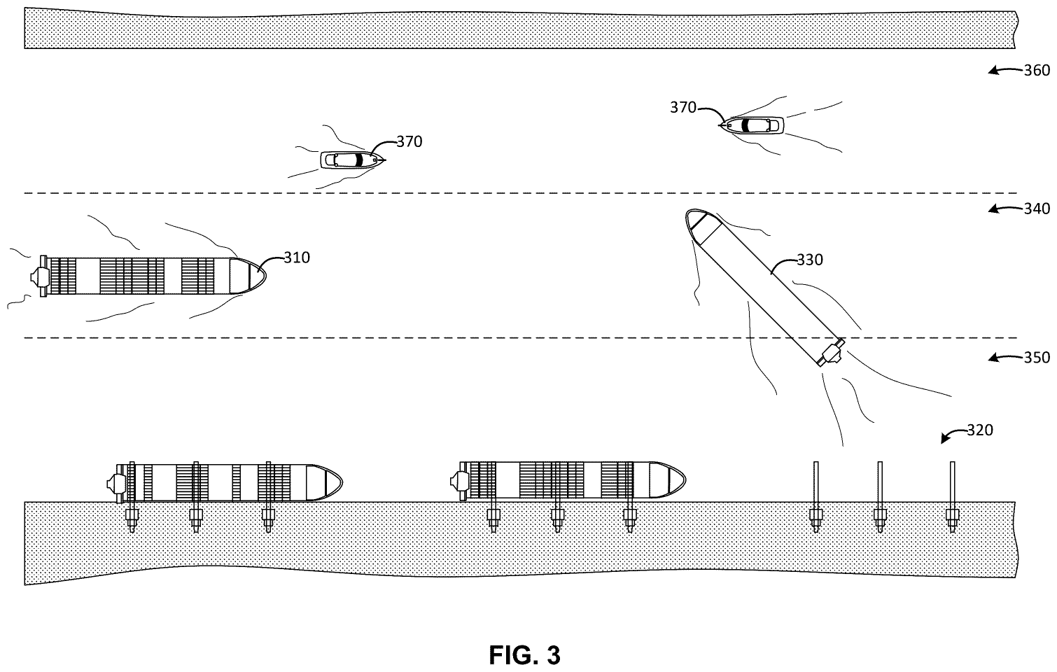

FIG. 3 is an illustration depicting an overhead view of an example scenario in which a signed document may be used in granting permissions related to water (or marine) vehicles navigating a waterway. Generally put, a privilege-granting authority (e.g., a port authority, coast guard, etc.) may establish and manage travel of water vehicles (e.g., commercial, government, and/or recreational ships and boats) in various waterways. Various channels within a waterway may be established for different types of use, including mixed-use channels.

In the scenario depicted in FIG. 3, a loaded cargo ship 310 navigating toward a dock 320 and/or an empty cargo ship 330 navigating away from the dock 320 may receive permissions for navigating to and from the dock 320. In particular, a central channel 340 in the waterway in which cargo ships are authorized to travel may not be sufficiently wide to allow the loaded cargo ship 310 to navigate past the empty cargo ship 330 and get to the dock 320. A privilege-granting authority may therefore grant permissions enabling the loaded cargo ship 310 and/or empty cargo ship 330 to temporarily enter a docking channel 350 and/or non-commercial channel 360, allowing the ships to navigate past each other. To grant permissions in a safe manner, a privilege granting authority may track the location of all water vehicles in the area. This may include knowing the location of non-cargo water vehicles 370, and possibly alerting the non-cargo water vehicles 370 of granted permissions given to the loaded cargo ship 310 and/or empty cargo ship 330 to temporarily enter the non-commercial channel 360.

Some embodiments may be utilized in applications other than road vehicles, water vehicles, and aerial vehicles. For example, low Earth orbit (LEO) satellites may be capable of altering their position or orbit (e.g., to avoid collisions with other satellites or space-bound objects). Using the techniques provided herein, embodiments may enable requesting a granting of permissions related to altering a position and/or orbit or conducting other movements by satellites and/or other space vehicles.

It can be further noted that applicable RF communications related to a particular application may be utilized in such applications. As indicated herein, V2X may be used for road traffic applications. Alternative RF communication technologies may be utilized for alternative applications relating to aerial vehicles, water vehicles and/or space vehicles.

FIG. 4 is a message-flow diagram of a process for requesting and granting vehicle privileges/permissions that may be performed in any of a variety of applications, including applications for road vehicles, water (or marine) vehicles, aerial vehicles, and space vehicles, as described herein. Optional operations are illustrated with dotted/dashed lines. In this example, a vehicle 405 (e.g. road, water, aerial or space vehicle) may communicate with a privilege-granting authority 410 via one or more intervening network devices 415. The network device(s) 415 may include radio towers, base stations, servers, relays, public and/or private data (and voice) communication networks (e.g., including a wide area network (WAN), the Internet, etc.), or combination thereof. The type(s) of network device(s) 415, networks, communication technologies, etc. may vary, depending on the application. As noted, V2X may be used in some applications, including applications for road vehicles. Additional or alternative wireless communication standards may be utilized, for example, in maritime and/or aerospace applications. The vehicle 405 may correspond to a device (e.g. a UE) that is part of a vehicle or otherwise associated with a vehicle (e.g. a device belonging to or carried by an operator or passenger of a vehicle).

The process may begin with the optional functionality of detecting a triggering event, as illustrated at block 420. Here, a triggering event may comprise an event that triggers the vehicle 405 to request permissions related to travel from the privilege-granting authority 410. According to some embodiments, a triggering event may comprise a determination by the vehicle 405 that it may not reach its destination at a desired time, or at all, without necessary permissions. This may occur before or during travel, and may be based on monitoring current travel, traffic conditions, etc. Other triggering conditions may correspond to a change in status of the vehicle (e.g., low on fuel/battery, engine/motor failure, etc.), an emergency condition (e.g., of the vehicle or an occupant), a need to travel in a certain manner or along a certain route, or a combination thereof.

Responsive to the triggering event, the vehicle 405 can establish a data connection or session (e.g. a TCP/IP connection) with the privilege-granting authority 410, as indicated at arrow 425. The establishment of a data connection may be governed by applicable protocols and standards. It can be noted that in some instances, a data connection may already be established between the vehicle 405 and the privilege-granting authority 410 prior to the detection of the triggering event at block 420. In such instances, the operation at arrow 425 may not be needed.

In some embodiments, the vehicle 405 may further send vehicle characteristics and/or vehicle requirements, as respectively indicated by arrows 430 and 435. As previously discussed, an aerial vehicle may indicate characteristics such as weight, fuel level, noise level, cargo type, etc., which may be taken into account by the privilege-granting authority 410 when determining whether to grant certain permissions. Vehicle requirements may comprise certain needs of the vehicle, for example, to deliver a payload, travel along a certain route, or reach a destination on time. Again, this may be taken into account by the privilege-granting authority 410 when determining whether to grant permissions, and which permissions to grant.

Although previously described with respect to aerial vehicles, there may be applications or embodiments involving other vehicle types in which the vehicle 405 sends vehicle characteristics, requirements, and/or other information to the privilege-granting authority 410 for determination of whether to grant certain permissions. This may be the case, for example, in a previously-described example in which a private road vehicle may be granted certain permissions to effectively become or act as a temporary emergency vehicle to transport a vulnerable person experiencing a medical emergency to an emergency room. In such instances, information may be provided regarding the type of emergency experienced by the vulnerable person, which may inform how urgently the vulnerable person needs to be transported to the emergency room. Some medical emergencies may be more urgent than others. And thus, more urgent medical emergencies may receive permissions (e.g., regarding maximum speeds, certain routes, etc.) to enable the vehicle 405 to reach the emergency room more quickly than with a less urgent medical emergency.

The vehicle 405 may then send a privilege request, shown by arrow 440) to the privilege-granting authority 410, which may then use the request (and any related information, such as vehicle characteristics/requirements) to determine whether to grant privileges, as shown at block 445. As previously indicated, some permissions may come at a monetary cost, in which case the privilege-granting authority 410 and vehicle 405 may engage in a financial transaction (not shown), in which the privilege-granting authority 410 may contact a financial institution, or may draw from a previously-funded account associated with the vehicle 405.

According to some embodiments, operations 420-445 may be automatic, manual, or a combination thereof. That is, the detection of the triggering event at block 420, subsequent communication between the vehicle 405 and privilege-granting authority 410, and determination to grant the privileges at block 445 may be performed automatically by the vehicle 405 (e.g., a UE integrated into the vehicle or other UE co-located with the vehicle) and a computer server acting on behalf of the privilege-granting authority 410, without human input. Alternatively, however, some or all of these operations may be performed manually (e.g., with at least some human intervention). Returning to the example in which permissions enable an ordinary private vehicle to effectively become or act as a temporary emergency vehicle, a human user may detect a health emergency (triggering event) of the vulnerable person and call an emergency services dispatcher (privilege-granting authority). The caller may also provide the emergency services dispatcher with information to enable the emergency services dispatcher to determine whether to grant the permissions, such as details regarding the emergency, the identity of the caller and/or the vulnerable person, details regarding the vehicle (license plate number/characteristics/requirements), or the like. A person at the emergency services dispatcher may decide to grant the vehicle permissions enabling the vehicle to exceed speed limits, receive green traffic lights, etc., similar to an emergency vehicle. (Again, this may be limited to a certain period of time and to a particular route or set of alternative routes.)

As indicated by arrow 450, the privilege-granting authority 410 may then create and transfer a signed document (e.g., electronically) to the vehicle 405 (or device located in the vehicle). Optionally, as indicated by arrow 455, the vehicle 405 may send an acknowledgment to the privilege-granting authority. As described in more detail below, the signed document may come in a variety of forms, which may vary depending on the type of vehicle, permissions, etc. In general, the format can include information such as an identification of the privilege-granting authority 410, an identification of the vehicle 405, any time permissions that were granted, a description or identification of the permissions and privileges granted at block 445, an expiration time of the permissions and privileges, a priority of the permissions and privileges and/or a priority of the vehicle 405, or any combination thereof. In some embodiments, information regarding a route for the vehicle 405 (e.g., geopolygon or a sequence of identified roads) may be included in the signed document.

Upon receipt of the signed document, the vehicle 405 (e.g., optionally) may be configured based on details and contents of the signed document, as indicated at block 460. This may comprise altering operation (e.g., adjusting routes, speeds, etc.) as well as configuring a wireless communication interface to send the signed document to other vehicle(s)/device(s) 465.

As indicated at block 470, the vehicle 405 also communicates the signed document to the other vehicle(s)/device(s) 465. As previously noted, this communication may be in unicast, groupcast/multicast or broadcast, and may utilize appropriate RF technologies and associated protocols and standards such as those supporting V2X, Proximity-based services (ProSe) as defined by the Third Generation Partnership Project (3GPP), sidelink RF signaling, etc. The other vehicle(s)/device(s) 465 may then verify the signed document. For example, each of the other vehicle(s)/device(s) 465 may verify a digital signature included in the signed document using a public key provided and authenticated by one or more digital certificates included in the signed document. Alternatively, if an unsigned document rather than a signed document is transferred at 450 and block 470, the other vehicle(s)/device(s) 465 may each employ real time document verification, as described earlier herein, to verify the unsigned document. The other vehicle(s)/device(s) 465 may then respond accordingly (e.g., changing lanes, flight paths, water channels or altitudes, adjusting traffic lights, etc.), to enable the vehicle 405 to exercise one or more of its granted privileges.

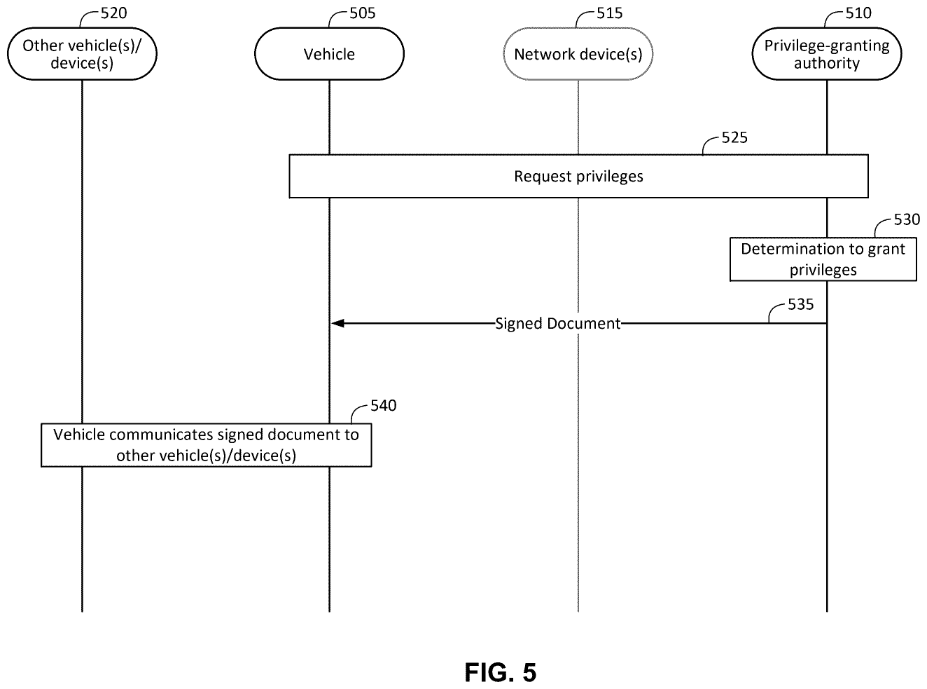

FIG. 5 is an extension and variant of the message-flow diagram of FIG. 4, in which all processes may be performed automatically by electronic devices (e.g., potentially without human intervention) such as vehicle 505 (which may correspond to vehicle 405), privilege-granting authority 510 (which may correspond to privilege-granting authority 410), network device(s) 515 (which may correspond to network device(s) 415), and other vehicle(s)/device(s) 520 (which may correspond to other vehicle(s)/device(s) 465). Here, the vehicle 505 may request privileges from the privilege-granting authority 510, as indicated at block 525, using any of a variety of data channels. These can include wireless communications, email, text (SMS), a Session Initiation Protocol (SIP) call, specialized or proprietary channels for privilege requests, etc. An international delivery service that utilizes drones, for example, may access a privilege-granting authority 510 for a particular delivery vehicle 505 using a specialized communication interface, application programming interface (API) call (e.g., when interfacing with a computer server of the privilege-granting authority 510), or the like.

It can be noted that, in some embodiments, there may be a seamless transition between placing a voice call (e.g. from vehicle 505) to privilege-granting authority 510 to request privileges and receiving via another medium a signed document from privilege-granting authority 510 indicating and certifying the privileges. In some embodiments, for example, a mobile phone associated with vehicle 505 may be used to place a request for privileges, and the privilege-granting authority 510 may then send to the mobile phone the signed document (e.g., via SMS, email, TCP/IP, an application, etc.). The mobile phone may then be used in the vehicle 505 to transmit the signed document to the other vehicle(s)/device(s) 520. Alternatively, the mobile phone may transfer the signed document to the vehicle 505 (e.g., using an application) via a wired or wireless technology, such as Bluetooth, Wi-Fi, USB, or the like.

As with other examples provided herein, the vehicle 505 may determine the privilege-granting authority 510 to which to send the request for the privileges based on a location and/or intended route of the vehicle 505 and the corresponding authorities having jurisdiction over the location/intended route. A vehicle 505 may send multiple requests for privileges (e.g., may repeat the operation illustrated at block 525) to multiple privilege-granting authorities in cases where the intended route is covered by multiple jurisdictions.

The determination to grant the privileges at block 530, the sending of a signed document indicating the privileges illustrated by the arrow 535, and the communication of the signed document to other vehicles/devices at block 540 may each proceed in a manner similar to the counterpart operations in FIG. 4. In some embodiments, a data channel used to send the signed document at arrow 535 may be the same data channel used to request the privileges at block 525. For example, the signed document may be sent using a communication channel set up when requesting the privileges. Again this can include wireless communications, email, text (SMS), SIP, TCP/IP, specialized or proprietary protocols and/or channels for privilege requests, etc.

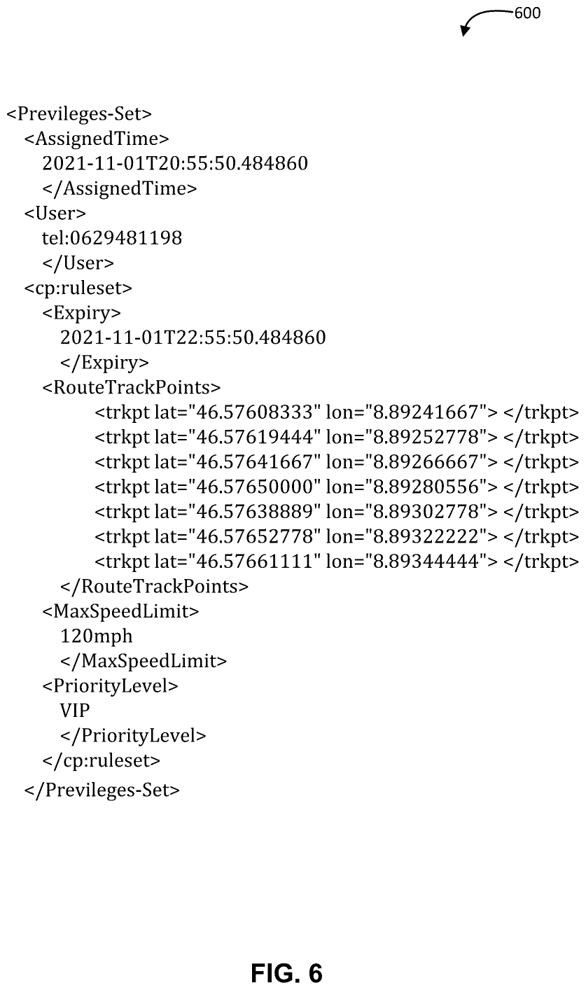

FIG. 6 shows example text data based on XML that can be included as part of a signed document to indicate permissions, or privileges, assigned to a vehicle or to a device associated with a vehicle according to an embodiment. Here, the text data includes an identity of a user (tel: 0629481198) associated with the vehicle and a time at which the permissions were assigned. The data also includes an expiration time and a route (indicated by a sequence of latitude/longitude locations) that apply to the permissions. The permissions include an increased maximum speed of travel (120 mph) and am increased priority level (VIP). Of course, different instances may include different data (e.g., reflecting different permissions, a different user, etc.), and different embodiments may use different formatting/structure for conveying permission data.

Embodiments that enable a vehicle to effectively become a temporary emergency vehicle may use the same or similar format to the one shown in FIG. 6 for conveying permissions. According to some embodiments, permissions and the signed document may be embedded in a single data structure, generally described as follows when based on ASN.1 encoding:

| | |
|---|---|
| Emergency_Signed document | SEQUENCE { |
| token | String, |
| duration | Time, |
| destinationName | String, |
| geoPolygon | Geopolygon, |
| signature | DigitalSignature, |
| certificates | DigitalCertificates |
| } | |

Here, the token may comprise a text, octet or binary string indicating privileges provided by the privilege-granting authority, the duration may indicate a validity period for the privileges, the destinationName may indicate a destination of the vehicle, the geoPolygon may indicate a geographic area within which the privileges are valid, the signature may contain a digital signature for the other parameters (e.g. a digital signature for a binary string or octet string that contains the token, the duration, the destinationName and the geoPolygon), and the certificates may contain one or more digital certificates providing and authenticating a public key used for the signature.

According to some embodiments, the data structure above may be included in a message, such as an emergency Vehicle Alert (EVA) message, transmitted by a privilege-granting authority to a vehicle granted permissions to become a temporary emergency vehicle and subsequently transmitted by this vehicle to other vehicles and other devices such as RSUs. An EVA may be a wireless message, defined in relevant V2X standards, that emergency vehicles may transmit to other vehicles and devices using V2X. Traditionally, private vehicles may not be provisioned to act as emergency vehicles. However, using the permission requesting and granting techniques provided herein, a privilege-granting authority such as an emergency service center (e.g., PSAP/emergency services dispatcher) may authorize a non-emergency vehicle to transmit EVA (and/or equivalent) messages. Again, this permission may be tied to a specific time limit and/or a specific geopolygon/set of routes. With this permission, the vehicle can then send EVA messages via V2X directly to other vehicles/devices which may enable various privileges for the vehicle as described herein.

According to some embodiments, the vehicle may send EVA messages to intervening devices that may relay these messages and/or control other devices. In the traffic scenario 100 of FIG. 1, for example, the privileged vehicle 105 may send an EVA message via a Uu wireless interface to a base station 125. The base station 125 can then relay this EVA message wirelessly to one or more other devices within its coverage area and/or to one or more remote devices (e.g., via the Internet).

Embodiments that enable a vehicle to effectively become a temporary emergency vehicle may modify an EVA message structure to enable this functionality. For example, an EVA message structure may be defined by a standard (e.g. SAE J2735), and the standard may be modified to enable embodiments described herein.

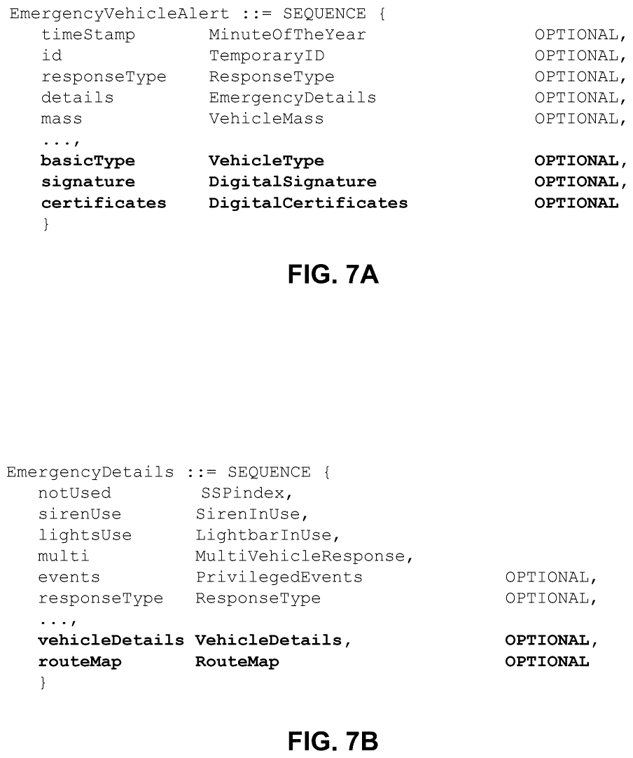

FIG. 7A shows example EVA message structure based on ASN.1 that could be used in such embodiments. The structure 700 shows the contents of a modified EVA message. In addition to data included in traditional EVA messages (e.g., timestamp, ID, details, etc.), the modified EVA message may include a “basicType” parameter in which a vehicle type is indicated as well as a signature parameter and a certificates parameter as described previously. According to embodiments, when a private vehicle becomes a temporary emergency vehicle, the vehicle type may be set as “private” or similar. For emergency vehicles, the vehicle type (if this parameter is included) may be set as “emergency,” “ambulance,” “police,” or similar.

FIG. 7B shows example modifications, based on ASN.1, to the “EmergencyDetails” parameter used in the EVA message of FIG. 7A. Here, in addition to previously-used parameters (sirenUse, lightsUse, etc.), EmergencyDetails may further comprise vehicleDetails and routeMap parameters. These parameters may, respectively, provide information regarding the privileged vehicle, as well as a route map associated with a route or set of routes along which the privileged vehicle may need to travel. Again, the route map may be defined using a geopolygon. The vehicle details parameter may include identification information for the vehicle, including a vehicle identification number (VIN) or other ID and/or other identifying features (e.g., whether it is a passenger car/truck/van, color, make, model, etc.).

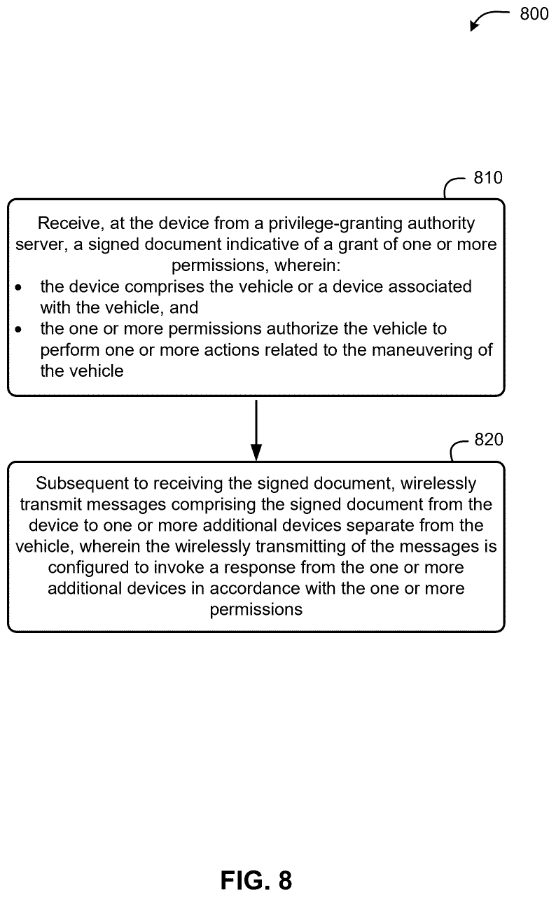

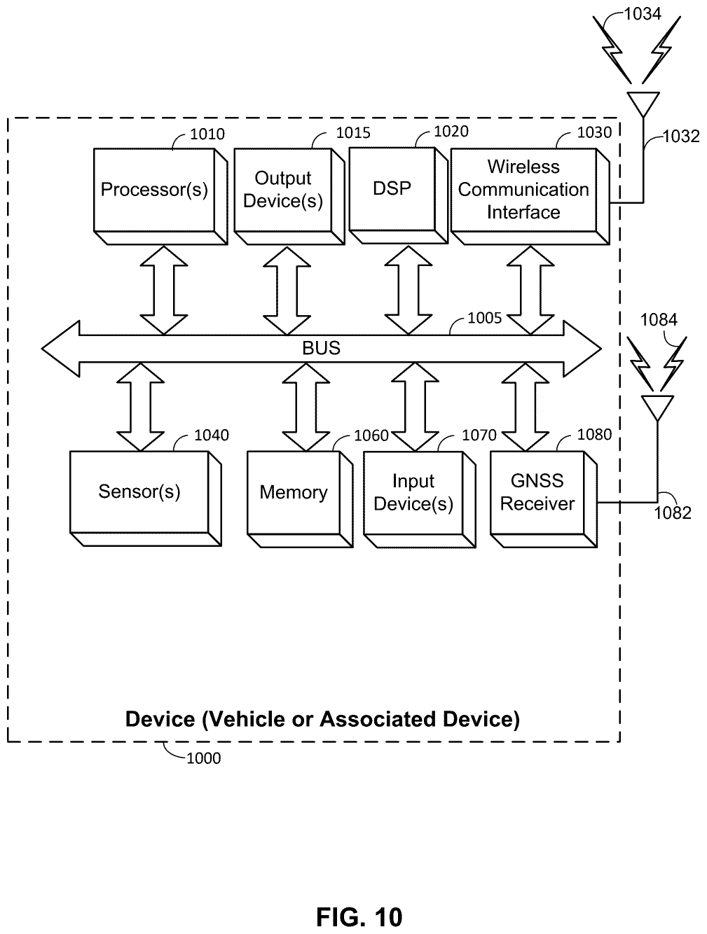

FIG. 8 is a flow diagram of a method 800 at a device for enabling permissions related to maneuvering of a vehicle, according to an embodiment. As described in more detail hereafter, the device may comprise the vehicle or a device associated with the vehicle, such as a mobile phone of a vehicle passenger or operator or a device (e.g. a modem or in vehicle system) that is attached to the vehicle. The operations shown in FIG. 8 may correspond with one or more operations performed by a vehicle or associated device in the previously-described embodiments. Means for performing the functionality illustrated in one or more of the blocks shown in FIG. 8 may be performed by hardware and/or software components of an electronic device, which may be a standalone device or integrated into a larger system or vehicle. Example components of such a device are illustrated in FIG. 10, which is described in more detail below.

The functionality of block 810 comprises receiving, at the device from a privilege-granting authority server, a signed document indicative of a grant of one or more permissions, wherein the device comprises the vehicle or an associated device, the associated device associated with the vehicle, and wherein the one or more permissions authorize the vehicle to perform one or more actions related to the maneuvering of the vehicle. As noted previously, the vehicle may comprise a road vehicle, an airborne vehicle, a marine vehicle, or a space vehicle. As indicated in the previously-described embodiments, the privilege-granting authority server may be maintained by a privilege-granting authority and may be capable of communicating signed documents to vehicles and/or other devices (e.g., via one or more network devices). The privilege-granting authority may comprise a government, agency, or other entity with jurisdiction over the maneuvering of vehicles along at least part of a route along which the vehicle has been, is or will be traveling.

The device itself may comprise the vehicle or subsystem thereof (e.g., a UE incorporated into a vehicle), or a device associated therewith. As indicated in the previously-described embodiments, an associated device may comprise a mobile phone or other device of a passenger or operator of the vehicle. More generally, an associated device may comprise a mobile device co-located with (e.g., in or on) the vehicle. According to some embodiments, the associated device may become associated with the vehicle based on information obtained by the privilege-granting authority that associates the device with the vehicle. This information may be included in a request for the one or more permissions or provided separately, and may identify the vehicle (e.g., using a VIN and/or other identifiers), the passenger/operator, and/or the associated device (e.g., using a unique ID, such as a telephone number, device ID/serial number, MAC address, etc.).

Means for performing functionality at block 810 may comprise a bus 1005, processor(s) 1010, DSP 1020, wireless communication interface 1030, sensors 1040, memory 1060, and/or other components of a device 1000, as illustrated in FIG. 10 and described hereafter.

The functionality of block 820 comprises subsequent to receiving the signed document, wirelessly transmitting messages comprising the signed document from the device to one or more additional devices separate from the vehicle, wherein the wirelessly transmitting of the messages is configured to invoke a response from the one or more additional devices in accordance with the one or more permissions. Here, the one or more additional devices may comprise receiving devices and/or vehicles that may be capable of responding in a way to allow the vehicle to exercise the granted permissions. As noted in the previously-described embodiments, receiving vehicles may move out of the way of the privileged vehicle to enable the privileged vehicle faster passage along the route, access to a particular dock or parking spot, etc. Receiving devices may comprise RSUs and/or other infrastructure devices that may be capable of changing traffic lights, moving tollbooth arms, moving or directing traffic, and/or otherwise changing conditions in a manner that enables the privileged vehicle to exercise its permissions.

Means for performing functionality at block 820 may comprise a bus 1005, processor(s) 1010, DSP 1020, wireless communication interface 1030, sensors 1040, memory 1060, and/or other components of a device 1000, as illustrated in FIG. 10 and described hereafter.

Depending on desired functionality, embodiments of the method 800 may include one or more additional features. For example, as described previously, the signed document may comprise an indication of the one or more permissions and a digital signature. The digital signature may be based on a public key-private key pair, where the signed document further comprises one or more digital certificates, and where the one or more digital certificates indicate and authenticate the public key.

According to some embodiments, the method 800 may further comprise determining a triggering event for requesting the one or more permissions, and sending, from the device to the privilege-granting authority server, a request for the one or more permissions, wherein receiving the signed document is responsive to the request. As noted in the above-described embodiments, types of triggering events may vary, depending on application. For example, a triggering event may comprise an existence of an emergency condition; a user input indicative of a desire to obtain the one or more permissions; a need to obtain the one or more permissions to travel along a certain route, to a certain destination, or at a certain time; a need to obtain the one or more permissions to travel in a certain manner; or a combination thereof.

As noted with respect to FIG. 4, the vehicle or device may send information to a privilege-granting authority to enable the privilege-granting authority to determine whether to grant permissions. Thus, some embodiments of the method 800 may further comprise sending vehicle information from the device to the privilege-granting authority server prior to receiving the signed document. In such embodiments, the vehicle information may be indicative of one or more characteristics of an operator or passenger of the vehicle, one or more characteristics of the vehicle, one or more requirements for maneuvering of the vehicle, or a combination thereof. A purpose of a trip and/or status of an operator/passenger may impact the determination of whether to grant the signed document. Thus, the one or more characteristics of the operator or the passenger of the vehicle may comprise a VIP status, employment as a doctor, government official, military official, or public safety official, having a medical condition, and/or performing an important or urgent action using the vehicle. Additionally or alternatively, the one or more characteristics of the vehicle may comprise a weight of the vehicle, a size of the vehicle, a type of the vehicle, a make of the vehicle, a model of the vehicle, a cargo of the vehicle, a maximum range of the vehicle, a maximum speed of the vehicle, a maximum altitude of the vehicle, or a measure of a noise of the vehicle, or a combination thereof.

Here, the maneuvering of the vehicle may relate to any type of action or motion the vehicle may take during the course of travel. Consequently, according to some embodiments of the method 800, the one or more actions related to the maneuvering of the vehicle may comprise accessing a shipping channel, flying area, roadway, or traffic lane; accessing a priority route of travel; using a certain parking spot, landing location, dock location, or Earth orbit; transporting a certain item or item type; moving to an alternate Earth orbit; traveling at a certain speed or range of speeds; traveling at a certain altitude or range of altitudes; performing one or more maneuvers; or a combination thereof.

The method 800 may include additional or alternative features described elsewhere herein. For example, the one or more permissions may be temporary. The signed document further may be indicative of a priority level of the one or more permissions. The device may wirelessly transmit the messages to the one or more additional devices separate from the vehicle while the vehicle travels along a route, wherein a selection of the route, a way in which the vehicle travels along the route, or both, is responsive to the response from the one or more additional devices. According to some embodiments, the method may further comprise receiving an updated signed document from the privilege-granting authority server, wirelessly transmitting the updated signed document from the device to further additional devices separate from the vehicle, and responsive to receiving the updated signed document or to responses from the further additional vehicles: adjusting the route, adjusting the way in which the vehicle travels along the route, or both.

The messages may comprise one or more V2X messages, one or more Proximity-based Services (ProSe) messages, one or more sidelink messages, or some combination of these. Depending on desired functionality, the messages or the signed document (or both) may further comprise information indicative of a destination of the vehicle, a time duration of the one or more permissions, a route of the vehicle, or a combination thereof. Wirelessly transmitting the messages may comprise broadcasting a message, multicasting a message (e.g. to a number of receiving devices), or transmitting a message by unicast to a specific receiving device. Transmitting the messages may comprise transmitting the messages using ProSe or sidelink communication. According to some embodiments, the method 800 may further comprise, subsequent to transmitting the messages, receiving one or more acknowledgements of receipt of the messages from the one or more additional devices.

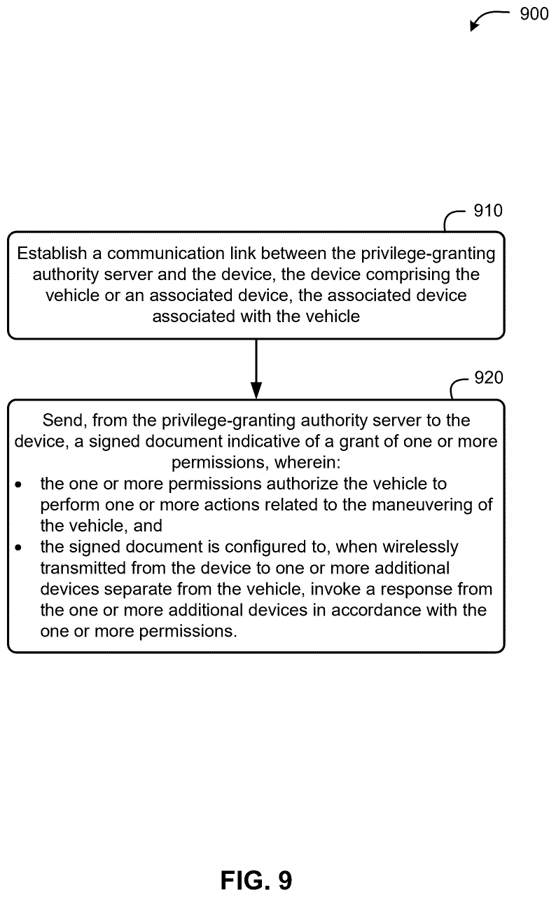

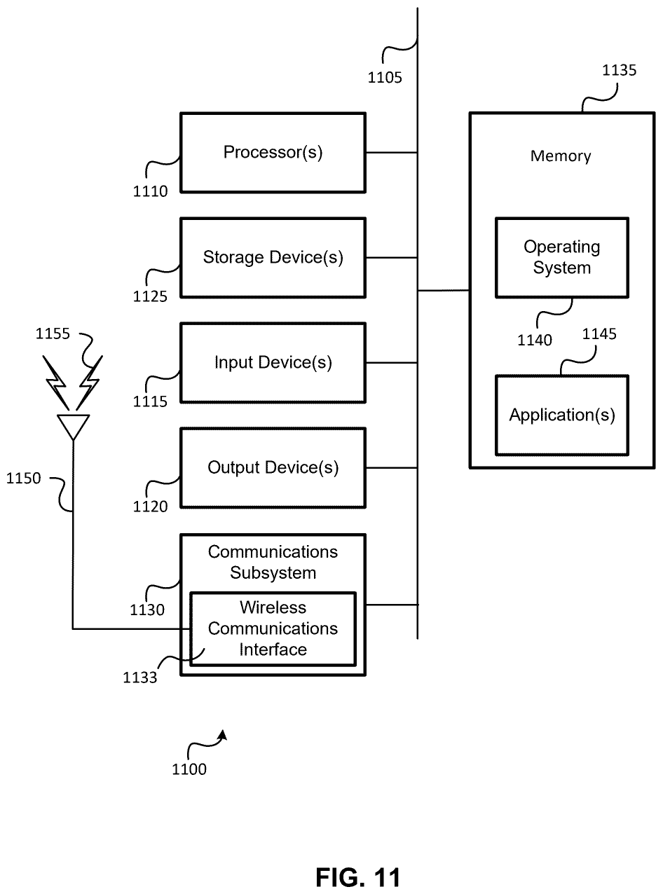

FIG. 9 is a flow diagram of a method 900 at a privilege-granting authority server for enabling a device to obtain and use permissions related to maneuvering of a vehicle, according to an embodiment. Again, the device may comprise a vehicle or a device associated with the vehicle. The operations shown in FIG. 9 may correspond with one or more operations performed by a privilege-granting authority server, as described in the embodiments provided herein. Means for performing the functionality illustrated in one or more of the blocks shown in FIG. 9 may be performed by hardware and/or software components of a computer system. Example components of such a computer system are illustrated in FIG. 11, which is described in more detail below.

The functionality of block 910 comprises establishing a communication link between the privilege-granting authority server and the device, the device comprising the vehicle or an associated device, the associated device associated with the vehicle. Again, depending on the application, the vehicle may comprise a road vehicle, an airborne vehicle, a marine vehicle, or a space vehicle. This application may further impact the communication technology utilized to establish the communication link. As previously indicated, different types of communication links may be governed by different types of standards/protocols. Means for performing functionality at block 910 may comprise a bus 1105, processor(s) 1110, DSP input device(s) 1115, communications subsystem 1130, memory 1135, and/or other components of a computer system 1100, as illustrated in FIG. 11 and described hereafter.

The functionality of block 920 comprises sending, from the privilege-granting authority server to the device, a signed document indicative of a grant of one or more permissions, wherein the one or more permissions authorize the vehicle to perform one or more actions related to the maneuvering of the vehicle, and the signed document is configured to, when wirelessly transmitted from the device to one or more additional devices separate from the vehicle, invoke a response from the one or more additional devices in accordance with the one or more permissions. As noted, this response may enable the vehicle to exercise its permissions.

In some embodiments, the privilege-granting authority server may include in the signed document an indication of the one or more permissions and a digital signature. The digital signature may be based on a public key-private key pair, and the privilege-granting authority server may include in the signed document one or more digital certificates, where the one or more digital certificates indicate and authenticate the public key.

As described herein, a determination of whether to grant the one or more permissions may be based on any of a variety of factors. Thus, according to some embodiments, the method 900 may further comprise, prior to sending the signed document, determining to grant the one or more permissions (e.g. as described for FIG. 4 and FIG. 5), where determining to grant the one or more permissions is based at least in part on a weather condition, an emergency condition related to the vehicle, a destination of the vehicle, a period of time during which the vehicle will travel with the one or more permissions, one or more characteristics of an operator or passenger of the vehicle, one or more characteristics of the vehicle, or one or more requirements of the vehicle, or a combination thereof. In such embodiments, the method 900 may further comprise determining a priority level of the one or more permissions; and including the priority level in the signed document. Additionally or alternatively, the method 900 may comprise receiving at the privilege-granting authority server, a request for the one or more permissions, wherein determining to grant the one or more permissions may be responsive to receiving the request for the one or more permissions. Additionally or alternatively, the method 900 may comprise receiving, at the privilege-granting authority server, vehicle information for the vehicle, where determining to grant the one or more permissions is based at least in part on the vehicle information, and where the vehicle information is indicative of one or more characteristics of an operator or passenger of the vehicle, one or more characteristics of the vehicle, one or more requirements for maneuvering of the vehicle, or a combination thereof. For example, the one or more characteristics of the operator or the passenger of the vehicle may comprise: a VIP status; employment as a doctor, government official, military official, or public safety official; having a medical condition; or performing an important or urgent action using the vehicle. For example, the one or more characteristics of the vehicle may comprise: a weight of the vehicle; a size of the vehicle; a type of the vehicle; a make of the vehicle; a model of the vehicle; a cargo of the vehicle; a maximum range of the vehicle; a maximum speed of the vehicle; a maximum altitude of the vehicle; a measure of a noise of the vehicle; or a combination thereof.

Means for performing functionality at block 920 may comprise a bus 1105, processor(s) 1110, DSP input device(s) 1115, communications subsystem 1130, memory 1135, and/or other components of a computer system 1100, as illustrated in FIG. 11 and described hereafter.

Embodiments may further employ one or more additional features, depending on desired functionality. For example, according to some embodiments, the one or more actions related to the maneuvering of the vehicle may comprise accessing a shipping channel, flying area, roadway or traffic lane; accessing a priority route of travel; using a certain parking spot, landing location, or dock location, or Earth orbit; transporting a certain item or item type; moving to an alternate Earth orbit; traveling at a certain speed or range of speeds; traveling at a certain altitude or range of altitudes; performing one or more maneuvers; or a combination thereof. Some embodiments of the method 900 may further comprise, subsequent to sending the signed document, determining to revoke the one or more permissions, and sending, from the privilege-granting authority server to the device, a message indicative of a revocation of the one or more permissions. Here, determining to revoke the one or more permissions may be based at least in part on a determination that the vehicle has arrived at a designated destination, a determination that the vehicle has left a designated route of travel of the vehicle, an emergency condition impacting a designated route of travel of the vehicle, a traffic condition impacting a designated route of travel of the vehicle, or a combination thereof.

FIG. 10 is a block diagram of an embodiment of a device 1000, which can be utilized as part of a vehicle (e.g., an electrical system of a vehicle) or as an associated device (e.g., mobile device, mobile phone, or other UE) as described herein (e.g., in association with FIGS. 1-9). For example, the device 1000 can perform one or more of the functions of the method shown in FIG. 8 and/or the more general functionality of a device, vehicle, and/or UE as described herein. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the devices and vehicles discussed in the previously described embodiments may be executed by one or more of the hardware and/or software components illustrated in FIG. 10.

The device 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The device 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The device 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the device 1000 to communicate with other devices as described in the embodiments above. The wireless communication interface 1030 may permit data and signaling to be communicated (e.g., transmitted and received) with wireless nodes of a network, for example, via eNBs, gNBs, ng-eNBs, access points, various base stations and/or other access node types, and/or other network components, computer systems, and/or any other electronic devices communicatively coupled with wireless nodes, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The device 1000 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3^{rd} Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The device 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the device 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the device 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The device 1000 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the device 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the device 1000 (and/or processor(s) 1010 or DSP 1020 within device 1000). In some embodiments, then, such code and/or instructions can be used to configure and/or adapt a general-purpose computer (or other device) to perform one or more operations in accordance with the described methods.

FIG. 11 is a block diagram of an embodiment of a computer system 1100, which may be used, in whole or in part, to provide the functions of one or more network components as described in the embodiments herein (e.g., a server). For example, the computer system 1100 can perform one or more of the functions of the method shown in FIG. 9 and/or the more general functionality of a privilege-granting authority server as described herein. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner. In addition, it can be noted that components illustrated by FIG. 11 can be localized to a single device and/or distributed among various networked devices, which may be disposed at different geographical locations.

The computer system 1100 is shown comprising hardware elements that can be electrically coupled via a bus 1105 (or may otherwise be in communication, as appropriate). The hardware elements may include processor(s) 1110, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1100 also may comprise one or more input devices 1115, which may comprise without limitation a mouse, a keyboard, a camera, a microphone, and/or the like; and one or more output devices 1120, which may comprise without limitation a display device, a printer, and/or the like.

The computer system 1100 may further include (and/or be in communication with) one or more non-transitory storage devices 1125, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1100 may also include a communications subsystem 1130, which may comprise wireless communication technologies managed and controlled by a wireless communication interface 1133, as well as wired technologies (such as Ethernet, coaxial communications, universal serial bus (USB), and the like). The wireless communication interface 1133 may comprise one or more wireless transceivers that may send and receive wireless signals 1155 (e.g., signals according to 5G NR or LTE) via wireless antenna(s) 1150. Thus the communications subsystem 1130 may comprise a modem, a network card (wireless or wired), an infrared communication device, a wireless communication device, and/or a chipset, and/or the like, which may enable the computer system 1100 to communicate on any or all of the communication networks described herein to any device on the respective network, including a User Equipment (UE), base stations and/or other TRPs, and/or any other electronic devices described herein. Hence, the communications subsystem 1130 may be used to receive and send data as described in the embodiments herein.

In many embodiments, the computer system 1100 will further comprise a working memory 1135, which may comprise a RAM or ROM device, as described above. Software elements, shown as being located within the working memory 1135, may comprise an operating system 1140, device drivers, executable libraries, and/or other code, such as one or more applications 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1125 described above. In some cases, the storage medium might be incorporated within a computer system, such as computer system 1100. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computer systems such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method at a device for enabling permissions related to maneuvering of a vehicle, the method comprising: receiving, at the device from a privilege-granting authority server, a signed document indicative of a grant of one or more permissions, wherein: the device comprises the vehicle or an associated device, the associated device associated with the vehicle, and the one or more permissions authorize the vehicle to perform one or more actions related to the maneuvering of the vehicle; and subsequent to receiving the signed document, wirelessly transmitting messages comprising the signed document from the device to one or more additional devices separate from the vehicle, wherein the wirelessly transmitting of the messages is configured to invoke a response from the one or more additional devices in accordance with the one or more permissions.

Clause 2. The method of clause 1, wherein the signed document comprises an indication of the one or more permissions and a digital signature.

Clause 3. The method of clause 2 wherein the digital signature is based on a public key-private key pair, wherein the signed document further comprises one or more digital certificates, the one or more digital certificates indicating and authenticating the public key.

Clause 4. The method of any one of clauses 1-3 wherein the vehicle comprises: a road vehicle, an airborne vehicle, a marine vehicle, or a space vehicle.

Clause 5. The method of any one of clauses 1-4 further comprising determining a triggering event for requesting the one or more permissions; and sending, from the device to the privilege-granting authority server, a request for the one or more permissions, wherein receiving the signed document is responsive to the request.

Clause 6. The method of clause 5 wherein the triggering event comprises: an existence of an emergency condition; a user input indicative of a desire to obtain the one or more permissions; a need to obtain the one or more permissions to travel along a certain route, to a certain destination, or at a certain time; a need to obtain the one or more permissions to travel in a certain manner; or a combination thereof.

Clause 7. The method of any one of clauses 1-6 further comprising sending vehicle information from the device to the privilege-granting authority server prior to receiving the signed document, wherein the vehicle information is indicative of one or more characteristics of an operator or passenger of the vehicle, one or more characteristics of the vehicle, one or more requirements for maneuvering of the vehicle, or a combination thereof.

Clause 8. The method of clause 7 wherein the one or more characteristics of the operator or the passenger of the vehicle comprise: a VIP status, employment as a doctor, government official, military official, or public safety official, having a medical condition, performing an important or urgent action using the vehicle, or a combination thereof.

Clause 9. The method of any one of clauses 7-8 wherein the one or more characteristics of the vehicle comprise: a weight of the vehicle, a size of the vehicle, a type of the vehicle, a make of the vehicle, a model of the vehicle, a cargo of the vehicle, a maximum range of the vehicle, a maximum speed of the vehicle, a maximum altitude of the vehicle, a measure of a noise of the vehicle, or a combination thereof.

Clause 10. The method of any one of clauses 7-9 wherein the one or more actions related to the maneuvering of the vehicle comprise: accessing a shipping channel, flying area, roadway, or traffic lane; accessing a priority route of travel; using a certain parking spot, landing location, dock location, or Earth orbit; transporting a certain item or item type; moving to an alternate Earth orbit; traveling at a certain speed or range of speeds; traveling at a certain altitude or range of altitudes; performing one or more maneuvers; or a combination thereof.

Clause 11. The method of any one of clauses 1-10 wherein the one or more permissions are temporary.

Clause 12. The method of any one of clauses 1-11 wherein the signed document is further indicative of a priority level of the one or more permissions.

Clause 13. The method of any one of clauses 1-12 wherein the device wirelessly transmits the messages to the one or more additional devices separate from the vehicle while the vehicle travels along a route, wherein a selection of the route, a way in which the vehicle travels along the route, or both, is responsive to the response from the one or more additional devices.

Clause 14. The method of clause 13 further comprising receiving an updated signed document from the privilege-granting authority server; wirelessly transmitting the updated signed document from the device to further additional devices separate from the vehicle; and responsive to receiving the updated signed document or to responses from the further additional vehicles: adjusting the route, adjusting the way in which the vehicle travels along the route, or both.

Clause 15. The method of any one of clauses 1-14 wherein the messages comprise one or more vehicle-to-everything (V2X) messages, one or more Proximity-based Services (ProSe) messages, one or more sidelink messages, or some combination of these.

Clause 16. The method of any one of clauses 1-15 wherein the messages or the signed document further comprise information indicative of: a destination of the vehicle, a time duration of the one or more permissions, a route of the vehicle, or a combination thereof.

Clause 17. The method of any one of clauses 1-16 wherein wirelessly transmitting the messages comprises: broadcasting a message, multicasting a message, or transmitting a message by unicast to a specific receiving device.

Clause 18. The method of any one of clauses 1-17 wherein transmitting the messages comprises transmitting the messages using proximity-based services (ProSe) or sidelink communication.

Clause 19. The method of any one of clauses 1-18 further comprising, subsequent to transmitting the messages, receiving one or more acknowledgements of receipt of the messages from the one or more additional devices.

Clause 20. A method at a privilege-granting authority server for enabling a device to obtain and use permissions related to maneuvering of a vehicle, the method comprising: establishing a communication link between the privilege-granting authority server and the device, the device comprising the vehicle or an associated device, the associated device associated with the vehicle; and sending, from the privilege-granting authority server to the device, a signed document indicative of a grant of one or more permissions, wherein: the one or more permissions authorize the vehicle to perform one or more actions related to the maneuvering of the vehicle, and the signed document is configured to, when wirelessly transmitted from the device to one or more additional devices separate from the vehicle, invoke a response from the one or more additional devices in accordance with the one or more permissions.

Clause 21. The method of clause 20, further comprising including in the signed document an indication of the one or more permissions and a digital signature.

Clause 22. The method of clause 21 wherein the digital signature is based on a public key-private key pair, and further comprising including, in the signed document, one or more digital certificates, the one or more digital certificates indicating and authenticating the public key.

Clause 23. The method of any one of clauses 20-22 wherein the vehicle comprises: a road vehicle, an airborne vehicle, a marine vehicle, or a space vehicle.

Clause 24. The method of any one of clauses 20-23 further comprising, prior to sending the signed document determining to grant the one or more permissions, wherein determining to grant the one or more permissions is based at least in part on: a weather condition, an emergency condition related to the vehicle, a destination of the vehicle, a period of time during which the vehicle will travel with the one or more permissions, one or more characteristics of an operator or passenger of the vehicle, one or more characteristics of the vehicle, one or more requirements of the vehicle, or a combination thereof.

Clause 25. The method of clause 24 further comprising determining a priority level of the one or more permissions; and including the priority level in the signed document.

Clause 26. The method of any one of clauses 24-25 further comprising receiving, at the privilege-granting authority server, a request for the one or more permissions, wherein determining to grant the one or more permissions is responsive to receiving the request for the one or more permissions.

Clause 27. The method of any one of clauses 24-26 further comprising receiving, at the privilege-granting authority server, vehicle information for the vehicle, wherein determining to grant the one or more permissions is based at least in part on the vehicle information, wherein the vehicle information is indicative of one or more characteristics of an operator or passenger of the vehicle, one or more characteristics of the vehicle, one or more requirements for maneuvering of the vehicle, or a combination thereof.

Clause 28. The method of clause 27 wherein the one or more characteristics of the operator or the passenger of the vehicle comprise: a VIP status, employment as a doctor, government official, military official, or public safety official, having a medical condition, or performing an important or urgent action using the vehicle, or a combination thereof.

Clause 29. The method of any one of clauses 27-28 wherein the one or more characteristics of the vehicle comprise: a weight of the vehicle, a size of the vehicle, a type of the vehicle, a make of the vehicle, a model of the vehicle, a cargo of the vehicle, a maximum range of the vehicle, a maximum speed of the vehicle, a maximum altitude of the vehicle, a measure of a noise of the vehicle, or a combination thereof.

Clause 30. The method of any one of clauses 27-29 wherein the one or more actions related to the maneuvering of the vehicle comprise: accessing a shipping channel, flying area, roadway or traffic lane; accessing a priority route of travel; using a certain parking spot, landing location, dock location, or Earth orbit; transporting a certain item or item type; moving to an alternate Earth orbit; traveling at a certain speed or range of speeds; traveling at a certain altitude or range of altitudes; performing one or more maneuvers; or a combination thereof.

Clause 31. The method of any one of clauses 20-30 further comprising subsequent to sending the signed document, determining to revoke the one or more permissions; and sending, from the privilege-granting authority server to the device, a message indicative of a revocation of the one or more permissions.

Clause 32. The method of clause 31 wherein determining to revoke the one or more permissions is based at least in part on: a determination that the vehicle has arrived at a designated destination, a determination that the vehicle has left a designated route of travel of the vehicle, an emergency condition impacting a designated route of travel of the vehicle, a traffic condition impacting a designated route of travel of the vehicle, or a combination thereof.

Clause 33. A device for enabling permissions related to maneuvering of a vehicle, the device comprising: a transceiver; a memory; and one or more processors communicatively coupled with the transceiver and the memory, wherein the one or more processors are configured to: receive, via the transceiver from a privilege-granting authority server, a signed document indicative of a grant of one or more permissions, wherein: the device comprises the vehicle or an associated device, the associated device associated with the vehicle, and the one or more permissions authorize the vehicle to perform one or more actions related to the maneuvering of the vehicle; and subsequent to receiving the signed document, wirelessly transmit messages comprising the signed document from the device to one or more additional devices separate from the vehicle, wherein the wirelessly transmitting of the messages is configured to invoke a response from the one or more additional devices in accordance with the one or more permissions.

Clause 34. The device of clause 33, wherein the signed document comprises an indication of the one or more permissions and a digital signature.

Clause 35. The device of clause 34 wherein the digital signature is based on a public key-private key pair, wherein the signed document further comprises one or more digital certificates, the one or more digital certificates indicating and authenticating the public key.

Clause 36. The device of any one of clauses 33-35 wherein the vehicle comprises: a road vehicle, an airborne vehicle, a marine vehicle, or a space vehicle.

Clause 37. The device of any one of clauses 33-36 wherein the one or more processors are further configured to: determine a triggering event for requesting the one or more permissions; and send, via the transceiver to the privilege-granting authority server, a request for the one or more permissions, wherein receiving the signed document is responsive to the request.

Clause 38. The device of clause 37 wherein the triggering event comprises: an existence of an emergency condition; a user input indicative of a desire to obtain the one or more permissions; a need to obtain the one or more permissions to travel along a certain route, to a certain destination, or at a certain time; a need to obtain the one or more permissions to travel in a certain manner; or a combination thereof.

Clause 39. The device of any one of clauses 33-38 wherein the one or more processors are further configured to send vehicle information from the device to the privilege-granting authority server prior to receiving the signed document, wherein the vehicle information is indicative of one or more characteristics of an operator or passenger of the vehicle, one or more characteristics of the vehicle, one or more requirements for maneuvering of the vehicle, or a combination thereof.

Clause 40. The device of any one of clauses 33-39 wherein the one or more permissions are temporary.

Clause 41. The device of any one of clauses 33-40 wherein the signed document is further indicative of a priority level of the one or more permissions.

Clause 42. The device of any one of clauses 33-41 wherein the one or more processors are further configured to wirelessly transmit the messages to the one or more additional devices separate from the vehicle while the vehicle travels along a route, wherein a selection of the route, a way in which the vehicle travels along the route, or both, is responsive to the response from the one or more additional devices.

Clause 43. The device of clause 42 wherein the one or more processors are further configured to: receive an updated signed document from the privilege-granting authority server; wirelessly transmit the updated signed document from the device to further additional devices separate from the vehicle; and responsive to receiving the updated signed document or to responses from the further additional vehicles: adjust the route, adjust the way in which the vehicle travels along the route, or both.

Clause 44. The device of any one of clauses 33-43 wherein the messages or the signed document further comprise information indicative of: a destination of the vehicle, a time duration of the one or more permissions, a route of the vehicle, or a combination thereof.

Clause 45. The device of any one of clauses 33-44 wherein, to wirelessly transmit the messages, the one or more processors are configured to broadcast a message, multicast a message, or transmit a message by unicast to a specific receiving device.

Clause 46. The device of any one of clauses 33-45 wherein, to transmit the messages, the one or more processors are configured to transmit the messages using proximity-based services (ProSe) or sidelink communication.

Clause 47. The device of any one of clauses 33-46 wherein the one or more processors are further configured to, subsequent to transmitting the messages, receive one or more acknowledgements of receipt of the messages from the one or more additional devices.

Clause 48. A privilege-granting authority server for enabling a device to obtain and use permissions related to maneuvering of a vehicle, the privilege-granting authority server comprising: a transceiver; a memory; and one or more processors communicatively coupled with the transceiver and the memory, wherein the one or more processors are configured to: establish a communication link between the privilege-granting authority server and the device, the device comprising the vehicle or an associated device, the associated device associated with the vehicle; and send, via the transceiver to the device, a signed document indicative of a grant of one or more permissions, wherein: the one or more permissions authorize the vehicle to perform one or more actions related to the maneuvering of the vehicle, and the signed document is configured to, when wirelessly transmitted from the device to one or more additional devices separate from the vehicle, invoke a response from the one or more additional devices in accordance with the one or more permissions.

Clause 49. The privilege-granting authority server of clause 48, wherein the one or more processors are further configured to include in the signed document an indication of the one or more permissions and a digital signature.

Clause 50. The privilege-granting authority server of clause 49 wherein the digital signature is based on a public key-private key pair, and the one or more processors are configured to include, in the signed document, one or more digital certificates, the one or more digital certificates indicating and authenticating the public key.

Clause 51. The privilege-granting authority server of any one of clauses 48-50 wherein the one or more processors are further configured to, prior to sending the signed document: determine to grant the one or more permissions, wherein determining to grant the one or more permissions is based at least in part on: a weather condition, an emergency condition related to the vehicle, a destination of the vehicle, a period of time during which the vehicle will travel with the one or more permissions, one or more characteristics of an operator or passenger of the vehicle, one or more characteristics of the vehicle, one or more requirements of the vehicle, or a combination thereof.

Clause 52. The privilege-granting authority server of clause 51 wherein the one or more processors are further configured to: determine a priority level of the one or more permissions; and include the priority level in the signed document.

Clause 53. The privilege-granting authority server of any one of clauses 51-52 wherein the one or more processors are further configured to receive, via the transceiver, a request for the one or more permissions, wherein the one or more processors are further configured to determine to grant the one or more permissions responsive to receiving the request for the one or more permissions.

Clause 54. The privilege-granting authority server of any one of clauses 51-53 wherein the one or more processors are further configured to receive, via the transceiver, vehicle information for the vehicle, wherein the one or more processors are configured to determine to grant the one or more permissions based at least in part on the vehicle information, wherein the vehicle information is indicative of one or more characteristics of an operator or passenger of the vehicle, one or more characteristics of the vehicle, one or more requirements for maneuvering of the vehicle, or a combination thereof.

Clause 55. The privilege-granting authority server of any one of clauses 48-54 wherein the one or more processors are further configured to: subsequent to sending the signed document, determine to revoke the one or more permissions; and send, via the transceiver to the device, a message indicative of a revocation of the one or more permissions.

Clause 56. The privilege-granting authority server of clause 55 wherein the one or more processors are configured to determine to revoke the one or more permissions based at least in part on: a determination that the vehicle has arrived at a designated destination, a determination that the vehicle has left a designated route of travel of the vehicle, an emergency condition impacting a designated route of travel of the vehicle, a traffic condition impacting a designated route of travel of the vehicle, or a combination thereof.

Clause 57. An apparatus having means for performing the method of any one of clauses 1-32.

Clause 58. A non-transitory computer-readable medium storing instructions, the instructions comprising code for performing the method of any one of clauses 1-32.

What is claimed is:

1. A method at a device for enabling permissions related to maneuvering of a vehicle, the method comprising:
receiving, at the device from a privilege-granting authority server, a signed document indicative of a grant of one or more permissions, wherein:
the device comprises the vehicle or an associated device, the associated device associated with the vehicle, and
the one or more permissions authorize the vehicle to perform one or more actions related to the maneuvering of the vehicle; and
subsequent to receiving the signed document, wirelessly transmitting messages comprising the signed document from the device to one or more additional devices separate from the vehicle, wherein the wirelessly transmitting of the messages is configured to invoke a response from the one or more additional devices in accordance with the one or more permissions.

2. The method of claim 1, wherein the signed document comprises an indication of the one or more permissions and a digital signature.

3. The method of claim 2, wherein the digital signature is based on a public key-private key pair, wherein the signed document further comprises one or more digital certificates, the one or more digital certificates indicating and authenticating the public key.

4. The method of claim 1, wherein the vehicle comprises:
a road vehicle,
an airborne vehicle,
a marine vehicle, or
a space vehicle.

5. The method of claim 1, further comprising:
determining a triggering event for requesting the one or more permissions; and
sending, from the device to the privilege-granting authority server, a request for the one or more permissions, wherein receiving the signed document is responsive to the request.

6. The method of claim 5, wherein the triggering event comprises:
an existence of an emergency condition;
a user input indicative of a desire to obtain the one or more permissions;
a need to obtain the one or more permissions to travel along a certain route, to a certain destination, or at a certain time;
a need to obtain the one or more permissions to travel in a certain manner; or
a combination thereof.

7. The method of claim 1, further comprising sending vehicle information from the device to the privilege-granting authority server prior to receiving the signed document, wherein the vehicle information is indicative of one or more characteristics of an operator or passenger of the vehicle, one or more characteristics of the vehicle, one or more requirements for maneuvering of the vehicle, or a combination thereof.

8. The method of claim 7, wherein the one or more characteristics of the operator or the passenger of the vehicle comprise:
a VIP status,
employment as a doctor, government official, military official, or public safety official,
having a medical condition,
performing an important or urgent action using the vehicle, or
a combination thereof.

9. The method of claim 7, wherein the one or more characteristics of the vehicle comprise:
a weight of the vehicle,
a size of the vehicle,
a type of the vehicle,
a make of the vehicle,
a model of the vehicle,
a cargo of the vehicle,
a maximum range of the vehicle,
a maximum speed of the vehicle,
a maximum altitude of the vehicle,
a measure of a noise of the vehicle, or
a combination thereof.

10. The method of claim 1, wherein the one or more actions related to the maneuvering of the vehicle comprise:
accessing a shipping channel, flying area, roadway, or traffic lane;
accessing a priority route of travel;
using a certain parking spot, landing location, dock location, or Earth orbit;
transporting a certain item or item type;
moving to an alternate Earth orbit;
traveling at a certain speed or range of speeds;
traveling at a certain altitude or range of altitudes;
performing one or more maneuvers; or
a combination thereof.

11. The method of claim 1, wherein the one or more permissions are temporary.

12. The method of claim 1, wherein the signed document is further indicative of a priority level of the one or more permissions.

13. The method of claim 1, wherein the device wirelessly transmits the messages to the one or more additional devices separate from the vehicle while the vehicle travels along a route, wherein a selection of the route, a way in which the vehicle travels along the route, or both, is responsive to the response from the one or more additional devices.

14. The method of claim 13, further comprising:
receiving an updated signed document from the privilege-granting authority server;
wirelessly transmitting the updated signed document from the device to further additional devices separate from the vehicle; and
responsive to receiving the updated signed document or to responses from the further additional vehicles:
adjusting the route,
adjusting the way in which the vehicle travels along the route, or both.

15. The method of claim 1, wherein the messages or the signed document further comprise information indicative of:
a destination of the vehicle,
a time duration of the one or more permissions,
a route of the vehicle, or
a combination thereof.

16. The method of claim 1, wherein wirelessly transmitting the messages comprises:
broadcasting a message,
multicasting a message, or
transmitting a message by unicast to a specific receiving device.

17. The method of claim 1, wherein transmitting the messages comprises transmitting the messages using proximity-based services (ProSe) or sidelink communication.

18. The method of claim 1, further comprising, subsequent to transmitting the messages, receiving one or more acknowledgements of receipt of the messages from the one or more additional devices.

19. A method at a privilege-granting authority server for enabling a device to obtain and use permissions related to maneuvering of a vehicle, the method comprising:
establishing a communication link between the privilege-granting authority server and the device, the device comprising the vehicle or an associated device, the associated device associated with the vehicle; and
sending, from the privilege-granting authority server to the device, a signed document indicative of a grant of one or more permissions, wherein:
the one or more permissions authorize the vehicle to perform one or more actions related to the maneuvering of the vehicle, and
the signed document is configured to, when wirelessly transmitted from the device to one or more additional devices separate from the vehicle, invoke a response from the one or more additional devices in accordance with the one or more permissions.

20. The method of claim 19, further comprising including in the signed document an indication of the one or more permissions and a digital signature.

21. The method of claim 20, wherein the digital signature is based on a public key-private key pair, and further comprising including, in the signed document, one or more digital certificates, the one or more digital certificates indicating and authenticating the public key.

22. The method of claim 19, wherein the vehicle comprises:
a road vehicle,
an airborne vehicle,
a marine vehicle, or
a space vehicle.

23. The method of claim 19, further comprising, prior to sending the signed document:
determining to grant the one or more permissions, wherein determining to grant the one or more permissions is based at least in part on:
a weather condition,
an emergency condition related to the vehicle,
a destination of the vehicle,
a period of time during which the vehicle will travel with the one or more permissions,
one or more characteristics of an operator or passenger of the vehicle,
one or more characteristics of the vehicle,
one or more requirements of the vehicle, or
a combination thereof.

24. The method of claim 23, further comprising:
determining a priority level of the one or more permissions; and
including the priority level in the signed document.

25. The method of claim 23, further comprising receiving, at the privilege-granting authority server, a request for the one or more permissions, wherein determining to grant the one or more permissions is responsive to receiving the request for the one or more permissions.

26. The method of claim 23, further comprising receiving, at the privilege-granting authority server, vehicle information for the vehicle, wherein determining to grant the one or more permissions is based at least in part on the vehicle information, wherein the vehicle information is indicative of one or more characteristics of an operator or passenger of the vehicle, one or more characteristics of the vehicle, one or more requirements for maneuvering of the vehicle, or a combination thereof.

27. The method of claim 26, wherein the one or more characteristics of the operator or the passenger of the vehicle comprise:
a VIP status,
employment as a doctor, government official, military official, or public safety official,
having a medical condition, or
performing an important or urgent action using the vehicle, or
a combination thereof.

28. The method of claim 26, wherein the one or more characteristics of the vehicle comprise:
a weight of the vehicle,
a size of the vehicle,
a type of the vehicle,
a make of the vehicle,
a model of the vehicle,
a cargo of the vehicle,
a maximum range of the vehicle,
a maximum speed of the vehicle,
a maximum altitude of the vehicle,
a measure of a noise of the vehicle, or
a combination thereof.

29. The method of claim 19, wherein the one or more actions related to the maneuvering of the vehicle comprise:
accessing a shipping channel, flying area, roadway or traffic lane;
accessing a priority route of travel;
using a certain parking spot, landing location, dock location, or Earth orbit;
transporting a certain item or item type;
moving to an alternate Earth orbit;
traveling at a certain speed or range of speeds;
traveling at a certain altitude or range of altitudes;
performing one or more maneuvers; or
a combination thereof.

30. The method of claim 19, further comprising:
subsequent to sending the signed document, determining to revoke the one or more permissions; and
sending, from the privilege-granting authority server to the device, a message indicative of a revocation of the one or more permissions.

31. The method of claim 30, wherein determining to revoke the one or more permissions is based at least in part on:
a determination that the vehicle has arrived at a designated destination,
a determination that the vehicle has left a designated route of travel of the vehicle,
an emergency condition impacting a designated route of travel of the vehicle,
a traffic condition impacting a designated route of travel of the vehicle, or
a combination thereof.

32. A device for enabling permissions related to maneuvering of a vehicle, the device comprising:
a transceiver;
a memory; and
one or more processors communicatively coupled with the transceiver and the memory, wherein the one or more processors are configured to:
receive, via the transceiver from a privilege-granting authority server, a signed document indicative of a grant of one or more permissions, wherein:
the device comprises the vehicle or an associated device, the associated device associated with the vehicle, and
the one or more permissions authorize the vehicle to perform one or more actions related to the maneuvering of the vehicle; and
subsequent to receiving the signed document, wirelessly transmit messages comprising the signed document from the device to one or more additional devices separate from the vehicle, wherein the wirelessly transmitting of the messages is configured to invoke a response from the one or more additional devices in accordance with the one or more permissions.

33. The device of claim 32, wherein the signed document comprises an indication of the one or more permissions and a digital signature.

34. The device of claim 33, wherein the digital signature is based on a public key-private key pair, wherein the signed document further comprises one or more digital certificates, the one or more digital certificates indicating and authenticating the public key.

35. The device of claim 32, wherein the vehicle comprises:
a road vehicle,
an airborne vehicle,
a marine vehicle, or
a space vehicle.

36. The device of claim 32, wherein the one or more processors are further configured to:
determine a triggering event for requesting the one or more permissions; and
send, via the transceiver to the privilege-granting authority server, a request for the one or more permissions, wherein receiving the signed document is responsive to the request.

37. The device of claim 36, wherein the triggering event comprises:
an existence of an emergency condition;
a user input indicative of a desire to obtain the one or more permissions;
a need to obtain the one or more permissions to travel along a certain route, to a certain destination, or at a certain time;
a need to obtain the one or more permissions to travel in a certain manner; or
a combination thereof.

38. The device of claim 32, wherein the one or more processors are further configured to send vehicle information from the device to the privilege-granting authority server prior to receiving the signed document, wherein the vehicle information is indicative of one or more characteristics of an operator or passenger of the vehicle, one or more characteristics of the vehicle, one or more requirements for maneuvering of the vehicle, or a combination thereof.

39. The device of claim 32, wherein the one or more permissions are temporary.

40. The device of claim 32, wherein the signed document is further indicative of a priority level of the one or more permissions.

41. The device of claim 32, wherein the one or more processors are further configured to wirelessly transmit the messages to the one or more additional devices separate from the vehicle while the vehicle travels along a route, wherein a selection of the route, a way in which the vehicle travels along the route, or both, is responsive to the response from the one or more additional devices.

42. The device of claim 41, wherein the one or more processors are further configured to:
receive an updated signed document from the privilege-granting authority server;
wirelessly transmit the updated signed document from the device to further additional devices separate from the vehicle; and
responsive to receiving the updated signed document or to responses from the further additional vehicles:
adjust the route,
adjust the way in which the vehicle travels along the route, or both.

43. The device of claim 32, wherein the messages or the signed document further comprise information indicative of:
a destination of the vehicle,
a time duration of the one or more permissions,
a route of the vehicle, or
a combination thereof.

44. The device of claim 32, wherein, to wirelessly transmit the messages, the one or more processors are configured to:
broadcast a message,
multicast a message, or
transmit a message by unicast to a specific receiving device.

45. The device of claim 32, wherein, to transmit the messages, the one or more processors are configured to transmit the messages using proximity-based services (ProSe) or sidelink communication.

46. The device of claim 32, wherein the one or more processors are further configured to, subsequent to transmitting the messages, receive one or more acknowledgements of receipt of the messages from the one or more additional devices.

47. A privilege-granting authority server for enabling a device to obtain and use permissions related to maneuvering of a vehicle, the privilege-granting authority server comprising:
a transceiver;
a memory; and
one or more processors communicatively coupled with the transceiver and the memory, wherein the one or more processors are configured to:
establish a communication link between the privilege-granting authority server and the device, the device comprising the vehicle or an associated device, the associated device associated with the vehicle; and
send, via the transceiver to the device, a signed document indicative of a grant of one or more permissions, wherein:
the one or more permissions authorize the vehicle to perform one or more actions related to the maneuvering of the vehicle, and
the signed document is configured to, when wirelessly transmitted from the device to one or more additional devices separate from the vehicle, invoke a response from the one or more additional devices in accordance with the one or more permissions.

48. The privilege-granting authority server of claim 47, wherein the one or more processors are further configured to include in the signed document an indication of the one or more permissions and a digital signature.

49. The privilege-granting authority server of claim 48, wherein the digital signature is based on a public key-private key pair, and the one or more processors are configured to include, in the signed document, one or more digital certificates, the one or more digital certificates indicating and authenticating the public key.

50. The privilege-granting authority server of claim 47, wherein the one or more processors are further configured to, prior to sending the signed document:
determine to grant the one or more permissions, wherein determining to grant the one or more permissions is based at least in part on:
a weather condition,
an emergency condition related to the vehicle,
a destination of the vehicle,
a period of time during which the vehicle will travel with the one or more permissions,
one or more characteristics of an operator or passenger of the vehicle,
one or more characteristics of the vehicle,
one or more requirements of the vehicle, or
a combination thereof.

51. The privilege-granting authority server of claim 50, wherein the one or more processors are further configured to:
determine a priority level of the one or more permissions; and
include the priority level in the signed document.

52. The privilege-granting authority server of claim 50, wherein the one or more processors are further configured to receive, via the transceiver, a request for the one or more permissions, wherein the one or more processors are further configured to determine to grant the one or more permissions responsive to receiving the request for the one or more permissions.

53. The privilege-granting authority server of claim 50, wherein the one or more processors are further configured to receive, via the transceiver, vehicle information for the vehicle, wherein the one or more processors are configured to determine to grant the one or more permissions based at least in part on the vehicle information, wherein the vehicle information is indicative of one or more characteristics of an operator or passenger of the vehicle, one or more characteristics of the vehicle, one or more requirements for maneuvering of the vehicle, or a combination thereof.

54. The privilege-granting authority server of claim 47, wherein the one or more processors are further configured to:
subsequent to sending the signed document, determine to revoke the one or more permissions; and
send, via the transceiver to the device, a message indicative of a revocation of the one or more permissions.

55. The privilege-granting authority server of claim 54, wherein the one or more processors are configured to determine to revoke the one or more permissions based at least in part on:
a determination that the vehicle has arrived at a designated destination,
a determination that the vehicle has left a designated route of travel of the vehicle,
an emergency condition impacting a designated route of travel of the vehicle,
a traffic condition impacting a designated route of travel of the vehicle, or
a combination thereof.
